(19) United States
(12) Patent Application Publication
(10) Pub. No.: US 2013/0124314 A1
(43) Pub. Date: May 16, 2013

(54) SYSTEM FOR MANAGING PROMOTIONS AND ACTIVITY INFORMATION IN A RESTAURANT

(71) Applicant: Murgesh Navar, San Jose, CA (US)

(72) Inventor: Murgesh Navar, San Jose, CA (US)

(21) Appl. No.: 13/674,913

(22) Filed: Nov. 12, 2012

Related U.S. Application Data
(60) Provisional application No. 61/558,409, filed on Nov. 10, 2011.

(51) Int. Cl. G06Q 30/02

(52) U.S. Cl. CPC G06Q 30/0251
USPC 705/14.53; 705/14.66; 705/14.58

(57) ABSTRACT

A system is provided for managing promotions and activity information in a restaurant. The system may be implemented as a network service that provides a series of interfaces or web pages to implement promotion and activity information management. Promotion information regarding a promotion offered by a restaurant merchant may be received. The promotion information may include a plurality of parameters. User information for one or more restaurant users may be accessed. A user may be matched to a promotion based on the user information and the promotion information. Activity information regarding a restaurant activity performed by the merchant may be received. The activity information may be also provided.

### BACKGROUND

Systems for promoting restaurants are known in the prior art. Companies like Groupon® and LivingSocial® mass-distribute restaurant promotions to mobile devices and electronic mail accounts associated with prospective customers. However, such systems pay little regard to customer loyalty and locality. Mass-distributing a restaurant promotion causes a large group of redeemers to simultaneously converge on a restaurant. Such recipients are often neither loyal nor local. Accordingly, they rarely result in repeat business for the restaurant. Dealing with large crowds of these one-time redeemers disturbs normal restaurant operations and disgruntles customers that are in fact loyal and local.

Systems for managing restaurant operations are also known in the prior art. They require merchants to use multiple sub-systems for each operation or task. Moreover, they require merchants to make transactions through third-parties. Restaurants need an improved system for managing promotions and other content.

### SUMMARY

In an embodiment, a system for managing promotions and activity information in a restaurant includes a processor, memory, and an application stored in memory. The application is executable by the processor to receive promotion information regarding a promotion offered by a restaurant merchant. In some embodiment, the promotion may be a deal. In other embodiments, the promotion may be a message. Persons of ordinary skill in the art will readily recognize that various other types of promotions exist within the context of the presently claimed invention. The promotion information may include a plurality of parameters. The application may also be executable to access user information for one or more restaurant users, match a user to a promotion based on the user information and the promotion information, receive activity information regarding a restaurant activity performed by the merchant, and provide the activity information.

In an embodiment, a method for managing promotions and activity information may begin with receiving promotion information regarding a promotion offered by a restaurant merchant. The promotion information may include a plurality of parameters. User information for one or more restaurant users may be accessed. The user information and promotion information may be used to match a user to a promotion. Activity information regarding a restaurant activity performed by the merchant may be received. Activity information may also be provided.

### BRIEF DESCRIPTION OF DRAWINGS

FIG. 1 is a block diagram of an exemplary system for managing promotions and activity information in a restaurant.

FIG. 2 is an exemplary method for managing promotions and activity information in a restaurant.

FIG. 3 is an exemplary interface for a business self registration page.

FIG. 4A is an exemplary interface for a venue setup page.

FIG. 4B is an exemplary interface for configuring venue POS information.

FIG. 4C is an exemplary interface for configuring venue working days and hours.

FIG. 4D is an exemplary interface for configuring venue payment options.

FIG. 5 is an exemplary interface for a venue management page.

FIG. 6 is an exemplary interface for a restaurant dashboard page.

FIG. 7 is an exemplary interface for a point-of-sale login page.

FIG. 8 is an exemplary interface for a point-of-sale restaurant dashboard page.

FIG. 9 is an exemplary interface for a menu management page.

FIG. 10 is an exemplary interface for a menu image library page.

FIG. 11 is an exemplary interface for a deals dashboard page.

FIG. 12 is an additional exemplary interface for a deals dashboard page.

FIG. 13 is an exemplary interface for a deal control page.

FIG. 14 is an additional exemplary interface for a deal control page.

FIG. 15 is an additional exemplary interface for a deal control page.

FIG. 16 is an additional exemplary interface for a deal control page.

FIG. 17 is an additional exemplary interface for a deal control page.

FIG. 18 is an exemplary interface for a deal scheduling page.

FIG. 19 is an exemplary interface for a point-of-sale deal control page.

FIG. 20 is an exemplary interface for a message control page.

FIG. 21 is an additional exemplary for a message control page.

FIG. 22 is an additional exemplary for a message control page.

FIG. 23 is an exemplary interface for a message history page.

FIG. 24 is an exemplary interface for an activity information page.

FIG. 25 is an exemplary interface for a point-of-sale activity information page.

FIG. 26 is an exemplary interface providing promotion performance data.

FIG. 27 is an exemplary interface providing loyalty performance data.

FIG. 28 is an exemplary interface providing gifting performance data.

FIG. 30 illustrates an exemplary mobile device system.

### DETAILED DESCRIPTION

A system is provided for managing promotions and activity information in a restaurant. Though restaurants are discussed herein for purposes of discussion, other entities may be used with the present technology. The system may be implemented as a network service. The service may provide a series of interfaces or web pages to implement promotion and activity information management.

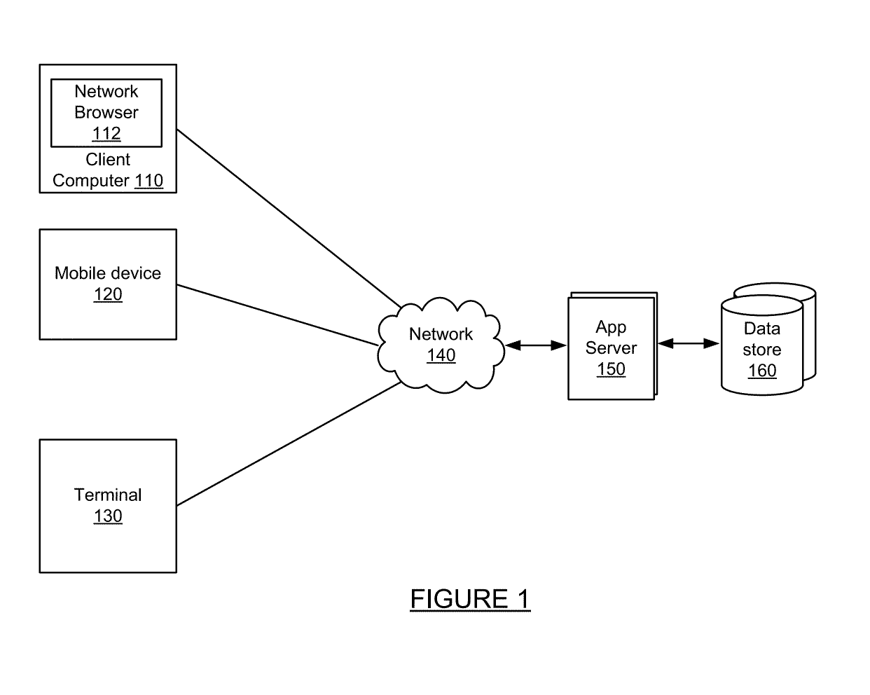

FIG. 1 is a block diagram of an exemplary system for managing promotions and activity information in a restaurant. In some embodiments, the system of FIG. 1 includes a client computer 110, mobile device 120, terminal 130, network 140, application server 150, and data store 160. Devices 110-130 may communicate with application server 150 over network 140. Network 140 may be implemented as a private network, public network, WAN, LAN, an intranet, the Internet, or a combination of these networks.

Client computer 110 may be implemented as a desktop, laptop, work station, notebook, tablet computer, or other computing device. Client computer 110 may include a network browser 112. Network browser 112 may include an application executable to receive content page data from network 140, render the data, provide an interface as a network page, and communicate with application server 150. In some embodiments, the network page may be implemented as a web page. The content received by application server 150 and provided by network browser 112 may relate to restaurant promotion management and restaurant activity management.

Mobile device 120 may include a smart phone, tablet computer, or other mobile device for accessing information over network 140. Mobile device 120 may include one or more applications for viewing content provided by application server 150 over network 140. Terminal 130 may include desktop, laptop, work station, notebook, tablet computer, or other computing device, and may also include one or more applications for viewing content provided by application server 150 over network 140. In some embodiments, the terminal may be located in a restaurant or other location.

Application server 150 may communicate with client computer 110, mobile device 120 and terminal 130, as well as with data store 160. Application server 150 may include one or more machines which provide a network service over network 140. The network service may allow restaurant or other merchants to manage promotions as well as restaurant and other activities. Data store 160 may store information such as merchant account data, promotion data, restaurant activity data and other data. Data in data store 160 may be stored, read, erased, accessed and otherwise processed by application server 150.

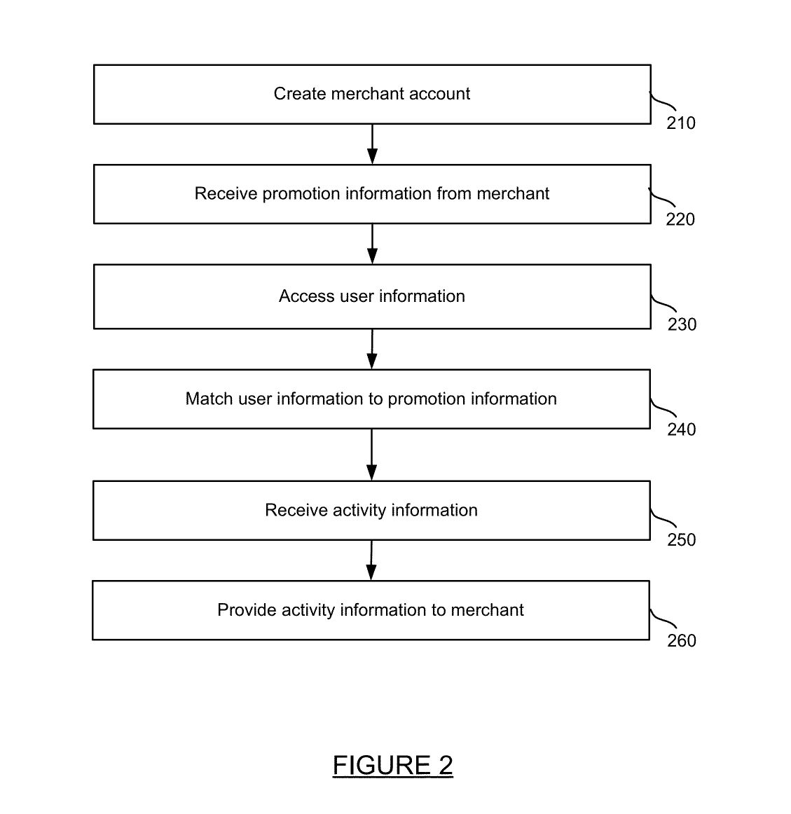

FIG. 2 is an exemplary method for managing promotions and activity information in a restaurant merchant. The method of FIG. 2 may be performed by one or more application servers 150. A merchant account may be created at step 210. Creation of an account may include receiving merchant contact information, a username and password, activity information for the merchant. Activity information may include hours of operation, menu information, location and contact information, services provided such as a catering, meals served, delivery, take-out, etc, and other information. Other information may also be received as part of creating an account. The received information is stored at a data store 160.

Promotion information may be received at step 220. The promotion information may include information for one or more promotions offered by the restaurant merchant, such as for example dine-in promotions, take-out promotions, delivery promotions, hours and dates associated with the promotion (e.g., expiration dates, valid-through dates) and other promotion information. The promotions information may be received as electronic form-filled data, images, text, audio, video, and other content. The promotion information may include details of the promotion as well as parameters for users at which the promotion is targeted. For example, the promotion may be targeted at people between the ages of 25 and 29 that live within 10 miles of the merchant's restaurant. The promotion information may be stored by application server 150 locally or at data store 160, or both, and associated with the merchant account which provided the promotion.

User information for one or more restaurant users may be accessed at step 230. The user information may be received from lists of user data, user accounts, or other sources. The user data may include information about the user such as address, food preferences, and other data.

A user may be matched to a promotion based on user information and the promotion information at step 240. The user information is compared to promotion parameters to determine what users are a match for the parameters. The match may correspond to the users the merchant is trying to target with the particular promotion.

Activity information regarding a restaurant activity performed by the merchant may be received at step 250. The activity information may include data received from a customer regarding a merchant activity. For example, the activity may include a take-out order, a reservation, or other activity.

Activity information may be provided to the merchant at step 260. The activity information may be provided to a computing device, mobile device or terminal operated by the merchant. For example, an order for take-out food received by a customer at step 250 may be received by application server 150 and provided to terminal 130 operated by the restaurant merchant.

Promotions provided by a merchant may be offered to one or more users (customers). The promotions may be transmitted by application server 150 via electronic mail, SMS message, telephone offers, or other methods. A merchant may manage the types and details of each promotion offered, the number of each promotion offered, the timing of the promotion, and other promotion information. The promotion may include information about deals, gifts, and events offered by the restaurant merchant.

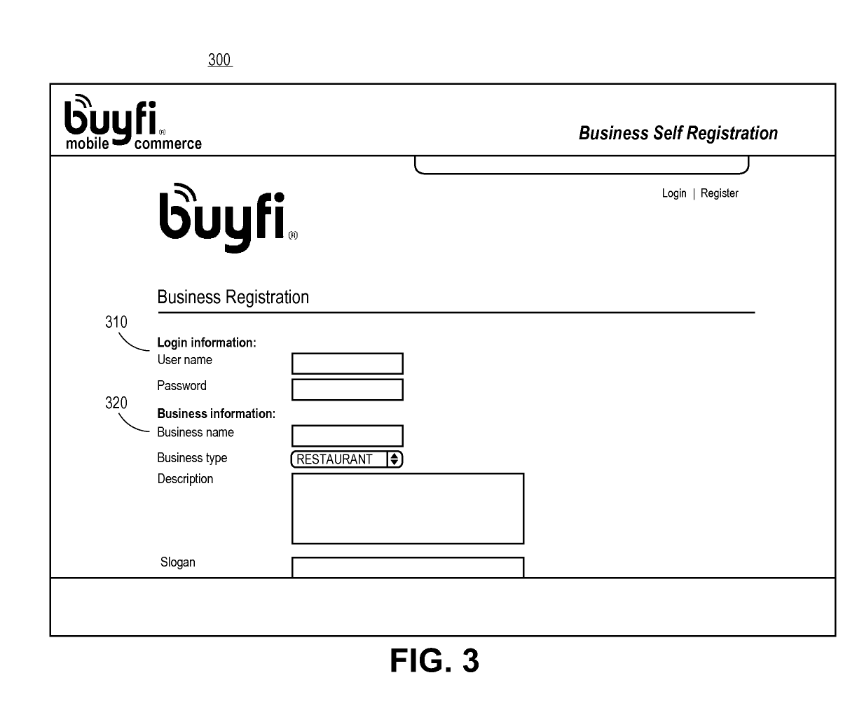

FIG. 3 is an exemplary interface for a registration page. In some embodiments, registration page 300 may include login area 310, which may include user name and password fields. A pre-registered business may log in to the system using a previously-registered name and password. Registration page 300 may also include business information area 320 for providing business details. Business information area 320 may include business name, business type, and other descriptive fields. In some embodiments, registration page 300 allows a merchant to self-register a restaurant without invitation or approval from the service provider.

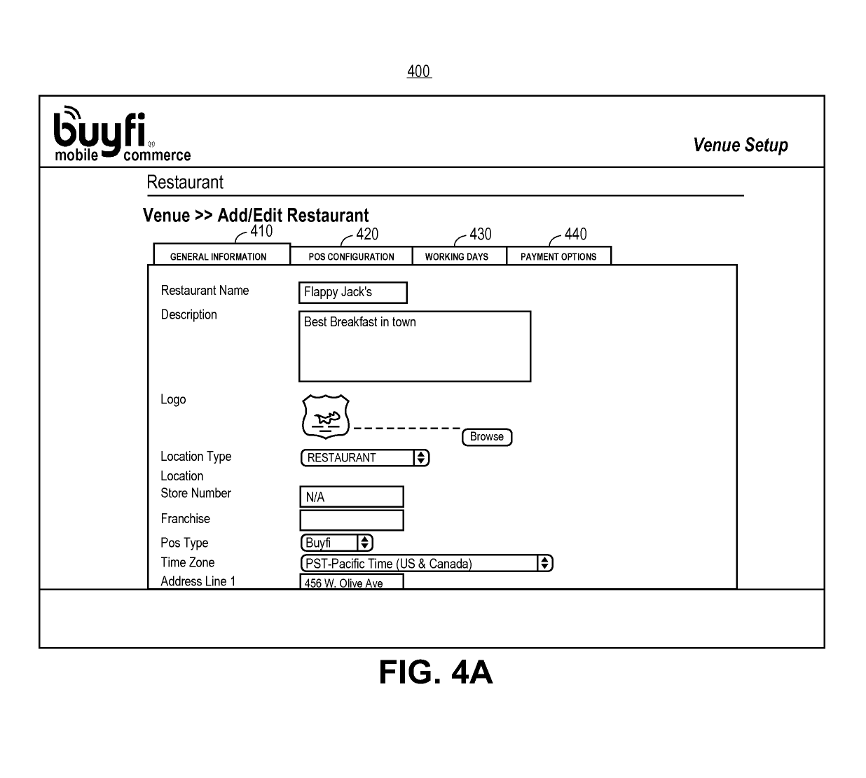

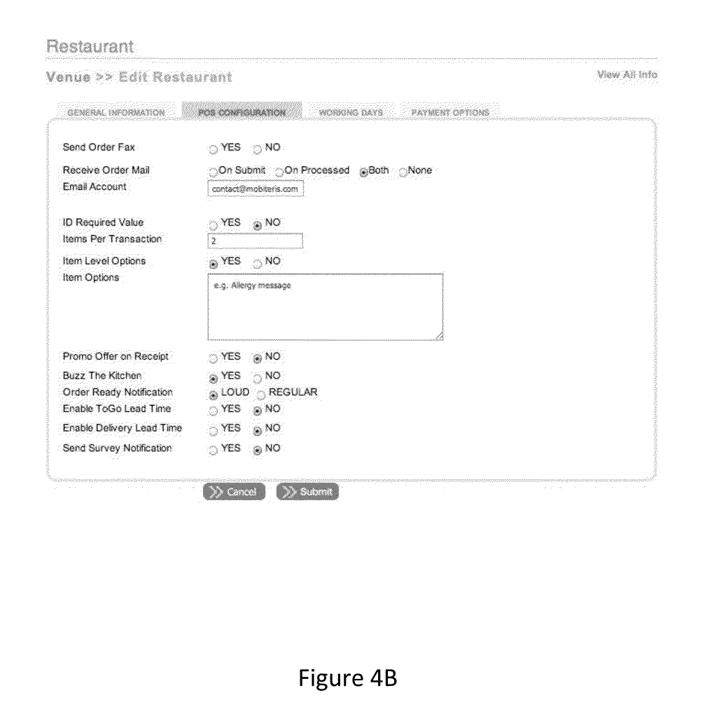

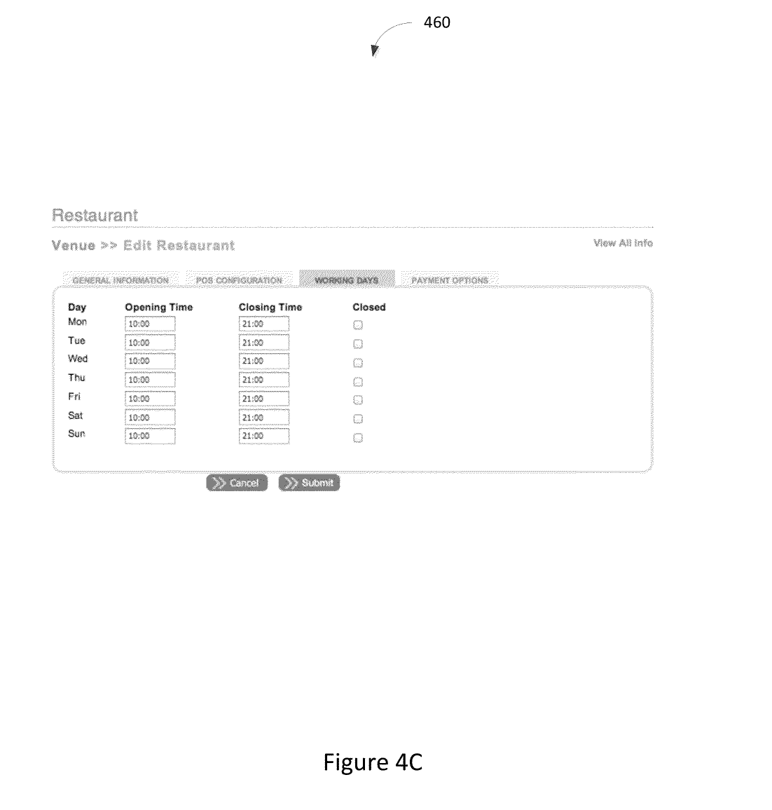

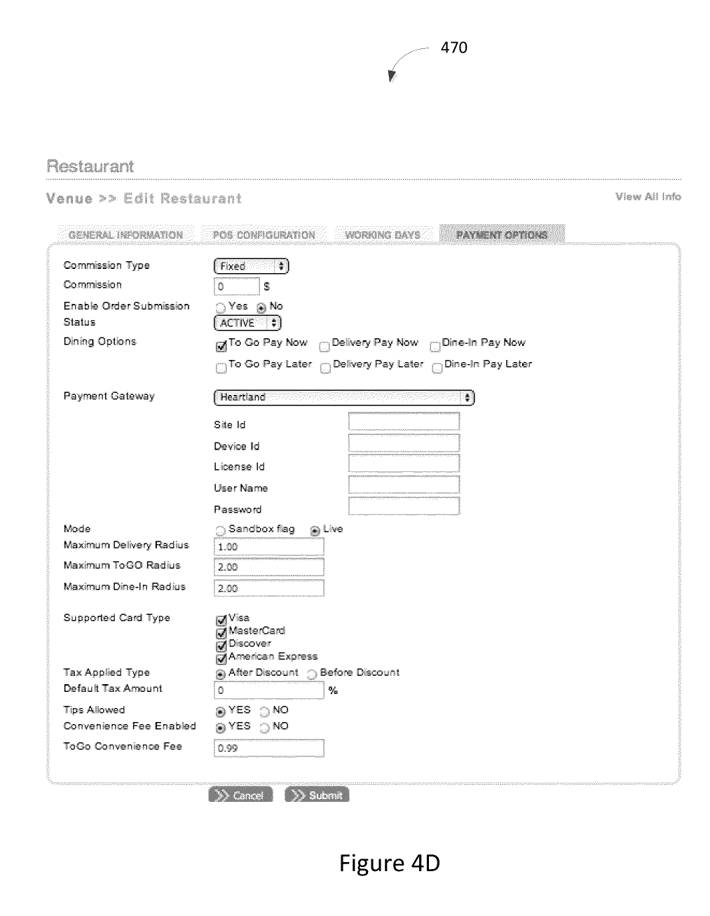

FIG. 4A is an exemplary interface for a venue setup page. In some embodiments, venue setup page 400 may include general information panel 410, point-of-sale configuration panel 420, working day panel 430, and payment options panel 440. The system may receive information about the restaurant at various fields relating to the name, description, logo, time zone, and other aspects of the restaurant. In some embodiments, the system may also receive point-of-sale configuration information at point-of-sale configuration panel 420, working day information at working day panel 430, or payment option information at payment options panel 440. Point-of-sale configuration panel 420 allows a merchant to link the presently claimed invention to a point-of-sale terminal. Working days panel 430 may allow a merchant to provide information regarding days that the restaurant is open for business. Payment options panel 440 may receive merchant account information and payment information. In some embodiments, the merchant account information allows any revenue resulting from restaurant activities to be deposited directly into the bank account of a merchant.

The interfaces provided by the present technology may allow the merchant to configure ancillary fees to be collected from the customer such as tax, convenience fees, allow for tips and fixed or percentage commission fees to be paid for service provider. Also, the interface allows a merchant to configure whether a customer can communicate by buzzing the kitchen directly with a text message, configuration to allow the customer to specify a time for pickup and delivery at the consumers convenience, if a promotional offer is to be printed on physical paper receipt, option to send a survey requesting directly to the phone upon completion of the order delivery seeing customer feedback and limitations on maximum number of items that can be ordered.

FIG. 4B is an exemplary interface 450 for configuring venue POS information. The interface of FIG. 4B may be provided when panel 420 is selected in FIG. 4A. The interface 450 allows a restaurant merchant administrator or other user to indicate point of sale preferences, such as for example indications of sending an order via facsimile, receiving order mail, email account, whether ID is required, items per transaction, specifying other options with an order (such as allergies), whether to offer a promotion on receipt, whether to notify a “kitchen”, whether to provide an order ready notification, enable a To Go lead time, enabling delivery lead time and sending survey notifications.

FIG. 4C is an exemplary interface for configuring venue working days and hours. The interface of FIG. 4C may be provided when panel 430 is selected in FIG. 4A. The interface 460 allows a merchant administrator to indicate what days and times a restaurant is open for business, as well as what days the restaurant is closed.

FIG. 4D is an exemplary interface 470 for configuring venue payment options. The interface 470 of FIG. 4D may be provided when panel 440 is selected in FIG. 4A. The interface 470 allows a merchant to configure payment options for a restaurant. The payment option configuration may include specifying a commission type, a commission amount, whether to enable order submissions, dining options of paying now or immediately or paying later for to go, delivery and dine-in eating, identifying a server gateway location and login information for payments, a specification as to where the restaurant will provide delivery, to go and dine-in service (e.g., a radius in miles), credit card types accepted, whether tips are allowed, whether convenience fees are enabled, and an amount for convenience fees.

The interface 470 of FIG. 4D allows a merchant to configure payment prior to order placement, or after an order has been delivered. The various options for delivering an order may include but are not limted to pickup in restaurant, pickup in drive-thru, pickup at curb, dine-in, home delivery, and so forth. Interface 470 also allows a merchant to specify distance limitations within which a customer can conduct transactions or receive promotions, such as for example a specified geo-fence within which an order is delivered, within which an order is released to the restaurant—automatically or manually—within which the customer is able to select items for ordering. The distance is calculated using the GPS locator functions built into mobile devices such as smart phones.

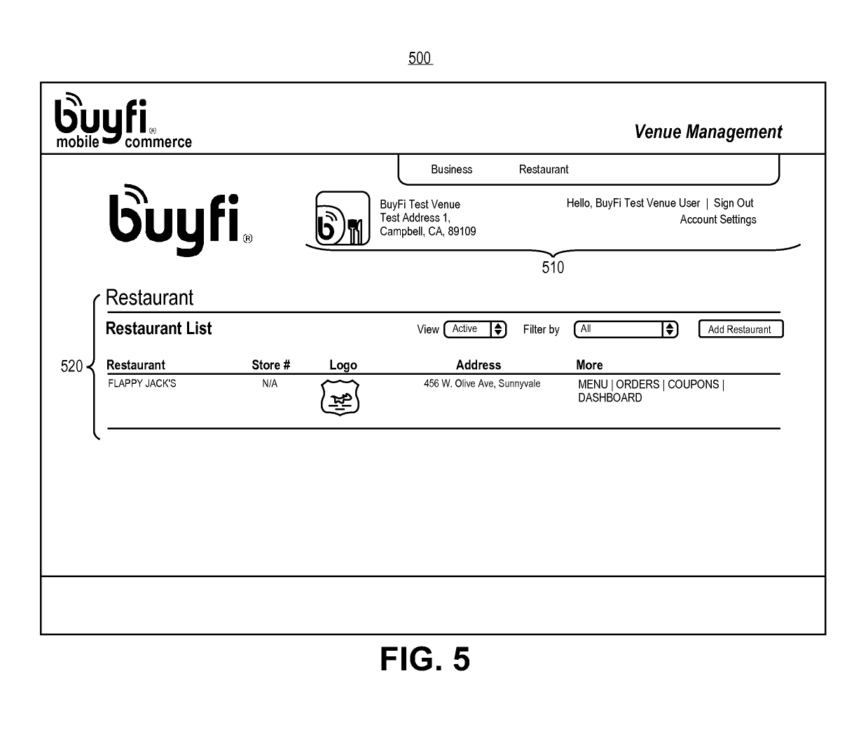

FIG. 5 is an exemplary interface for a venue management page. In some embodiments, venue management page 500 may include identification pane 510 and restaurant list 520. Identification pane 510 may display basic information about the restaurant such as a name and address. Restaurant list 520 may display a list of restaurants sorted by various attributes such as name, store number, logo, or address. Restaurant link 520 may also include selectable links that, when selected, provide other additional information for the particular restaurant.

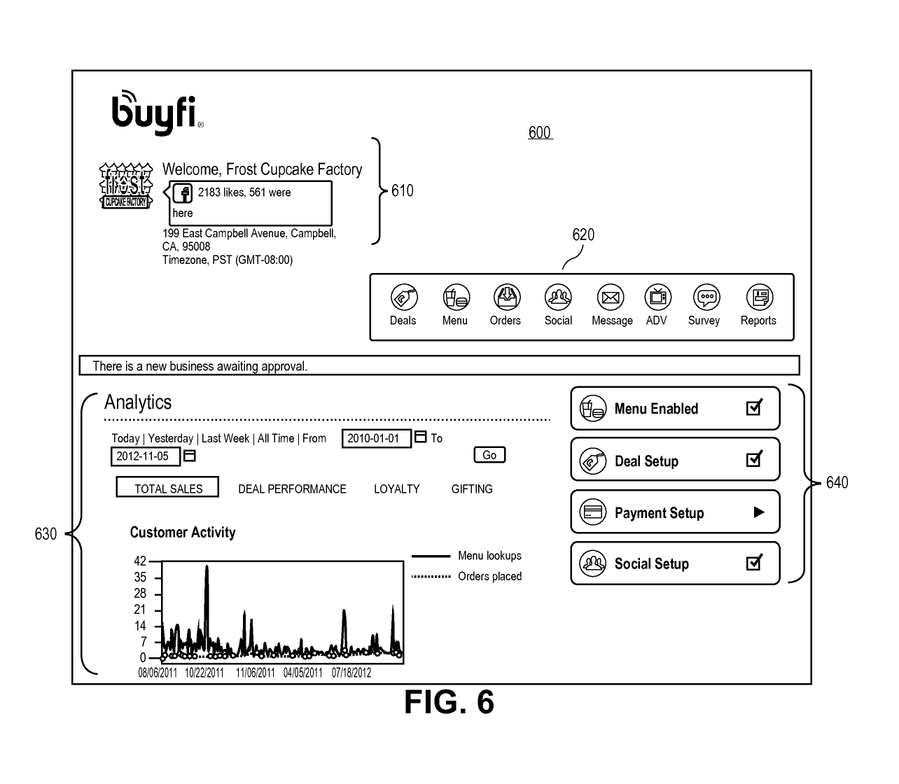

FIG. 6 is an exemplary interface for a restaurant dashboard page. In some embodiments, restaurant dashboard page 600 may include greeting area 610, toolbar 620, analytics window 630, and setup indicator area 640. Greeting area 610 may display a general greeting and basic information about the restaurant such as a name, address, and time zone. Greeting area 610 may also include information gathered from social media accounts associated with the restaurant. Such information may include the number of Facebook® users that have visited the “Facebook® Page” associated with the restaurant or the number of “Facebook® Likes” that users have associated with the restaurant. Toolbar 620 may include selectable icons that link to other interfaces within the system. When selected, each icon provides an interface associated with that particular icon. The icons may be associated with a deals interface, menu interface, orders interface, social activity interface, messaging interface, ADV interface, survey interface and reports interface. Analytics window 630 may include analytics related to the restaurant, such as data relating to the number of times a menu was viewed, the number of orders placed or total sales in a particular time period, deal performance, customer loyalty, or gifting. Setup indicator 640 may include indicators that communicate whether or not a particular feature of the system has been successfully set up or engaged. Such features may relate to menus, promotions, payment options, social media and other areas.

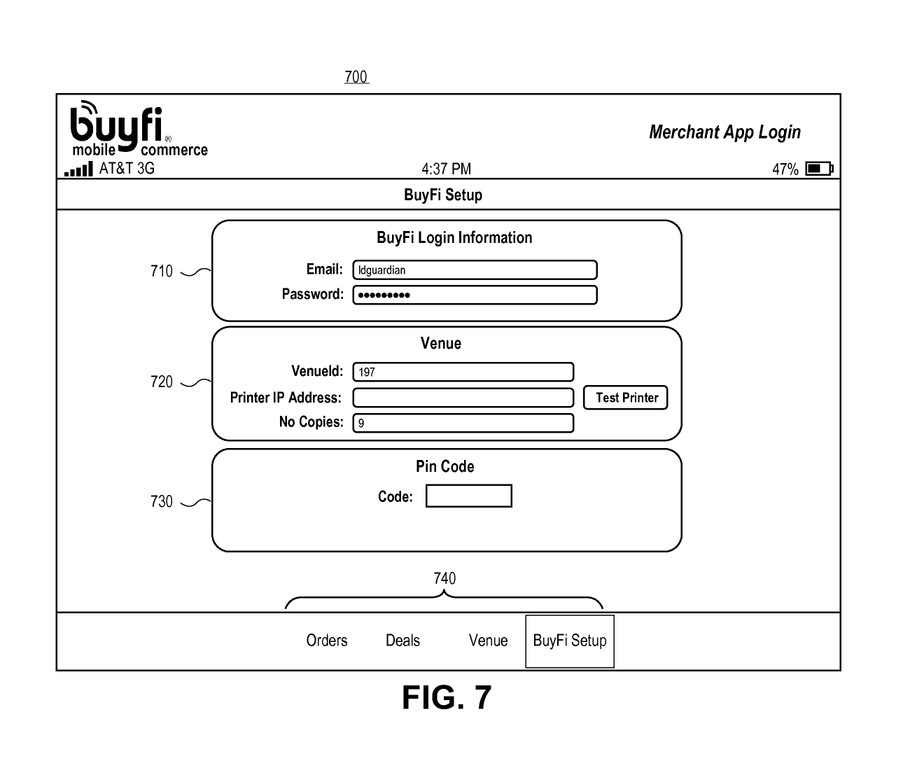

FIG. 7 is an exemplary interface for a merchant login page. In some embodiments, promotion and activity information may be received from and provided to a merchant through a service provided over a network. Merchant login page 700 may include merchant login area 710, printer test area 720, pin code area 730, and application toolbar 740. Merchant login page 700 may be displayed on a point-of-sale terminal in the restaurant. Merchant login area 710 may allow a merchant to enter previously login information such as an email and password. Printer test area 720 may receive a venue identification number, a printer IP address, or other fields that then allow the merchant to test a network printer. Pin code area 730 may include a field for entering a pin code uniquely associated with a merchant. Application toolbar 740 may include selectable icons that link to other interfaces within the system.

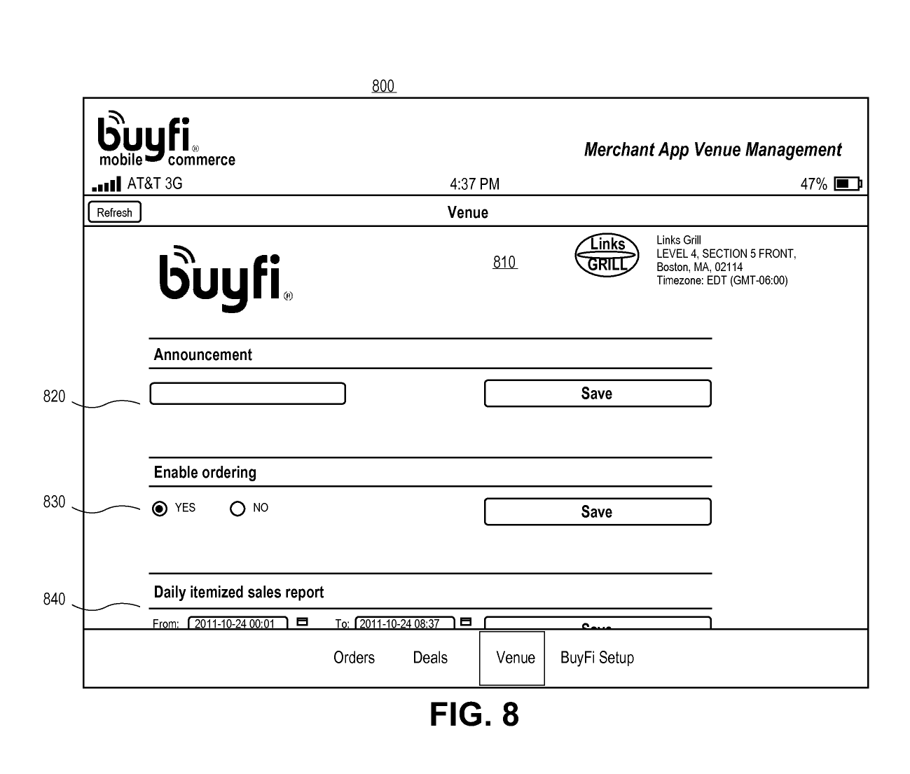

FIG. 8 is an exemplary interface for a merchant restaurant dashboard page. In some embodiments, merchant restaurant dashboard page 800 may include identification pane 810, announcement field 820, order control area 830, and sales report area 840. Merchant dashboard page 800 may be displayed through an application on a mobile device. Identification pane 810 may display basic information about the restaurant such as a name, address, and time zone. Announcement field 820 may include a field for receiving an announcement that the merchant wants to associate with the restaurant. Order control area 830 may include selectable buttons for enabling or disabling the ability of the presently claimed invention to receive activity information. In some embodiments, the activity information may include restaurant orders. Persons of ordinary skill in the art will readily recognize that other possible embodiments may include other forms of activity information. Sales report area 840 may include fields for receiving a date range for which the merchants wants to view a sales report. The sales report area 840 may include a selectable link that, when selected, provides sales report information.

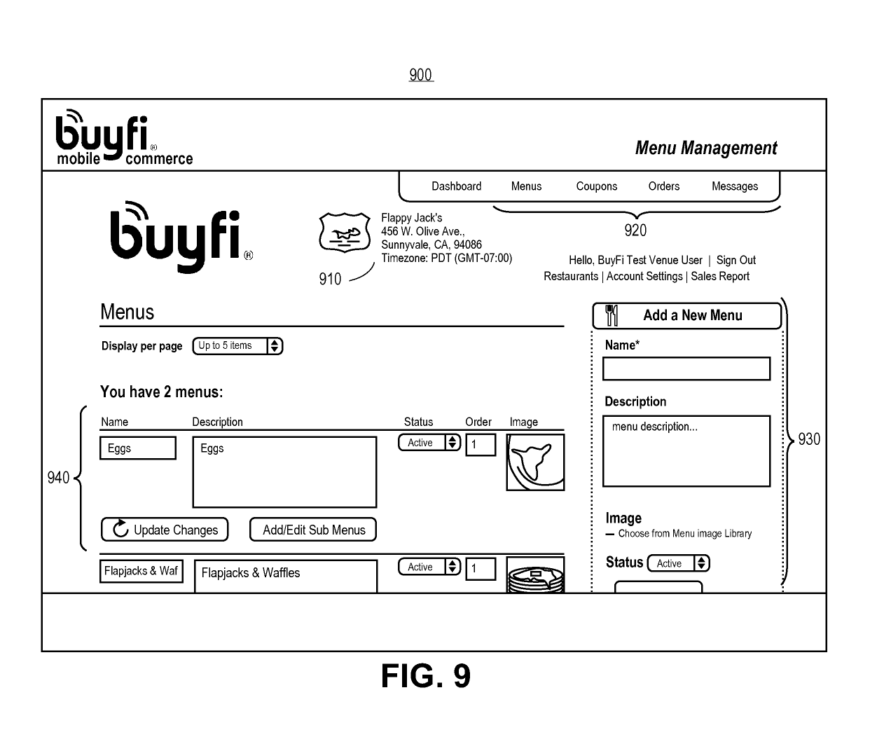

FIG. 9 is an exemplary interface for a menu management page. In some embodiments, menu management page 900 may include identification pane 910, toolbar 920, menu creation area 930, and sub-menu creation area 940. Identification pane 910 may display basic information about the restaurant such as a name, address, and time zone. Toolbar 920 may include selectable icons that link to other interfaces within the system, such as a dashboard, menu interface, coupon interface, order interface and messaging interface. When selected, each icon provides an interface associated with that particular icon. The menu creation area 930 may include fields for receiving information from the merchant for configuring a new menu. Such fields may include a menu name (i.e., “lunch menu”), a description of the menu, an image to associate with the menu, and the current status of the menu. Menu creation area 930 may also include a selectable link that, when selected, generates a new menu by incorporating information received from the merchant. Sub-menu creation area 940 may include fields for receiving information from the merchant for configuring new menu items. Such fields may include the name of the item, a description of the item, an image to associate with the item, a number to associate with the item, and the current status of the item. Sub-menu creation area 940 may also include selectable links that, when selected, generates a new item or updates an existing item by incorporating information received from the merchant. In some embodiments, sub-menu creation area 940 may automatically associate an image with a particular menu item.

In some embodiments, menu creation area 930 may be populated with a previously created menu. If a merchant already has a satisfactory menu, the merchant can upload it directly into the menu management page. In some embodiments, the menu management page 900 may be linked to various menu directories. For example, if the merchant has already posted a menu somewhere on the Internet such as FourSquare® or Facebook®, the merchant can import the existing menu into the menu management page 900. In yet another embodiment, the menu management page 900 may be linked directly to a point-of-sale system. The menu used by the point-of-sale system would then be imported directly into the menu management page 900.

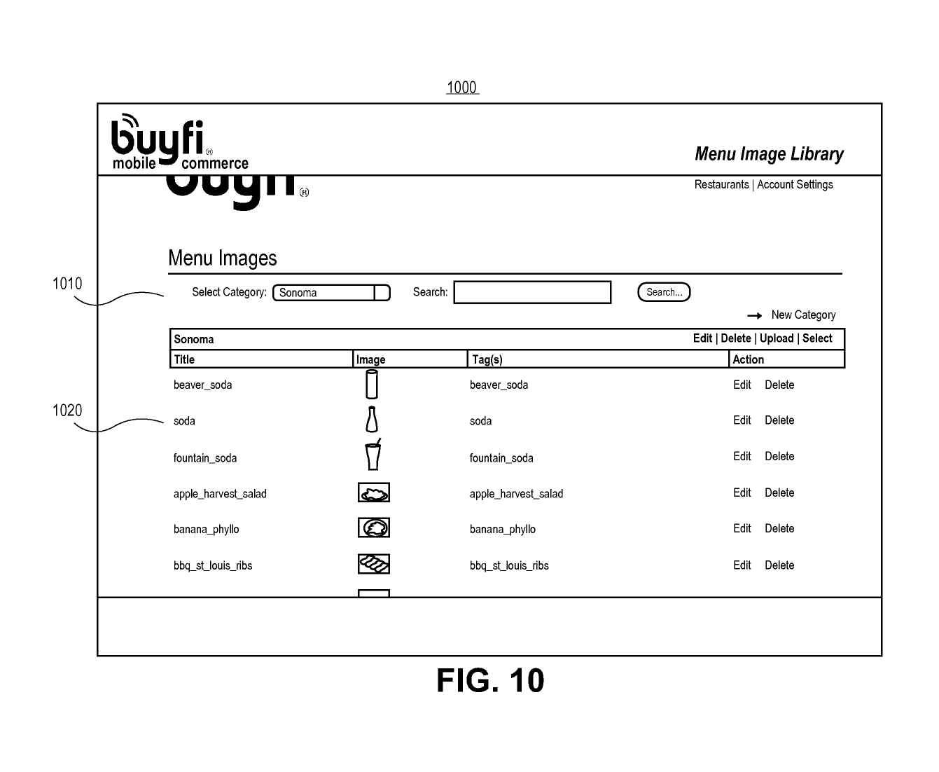

FIG. 10 is an exemplary interface for a menu image library page. In some embodiments, menu image library page 1000 may include image search bar 1010 and image list 1020. Image search bar 1010 may include a field for receiving keywords from the merchant and a category dropdown menu for further defining the image search. Image list 1020 may display a list of images that the merchant can select to associate with menus and menu items. Image list 1020 may also provide a selectable links that allows a merchant to upload an image and edit the title and tags associated with an image. Menu image library page 1000 allows a merchant to manually associate an image with a particular menu item.

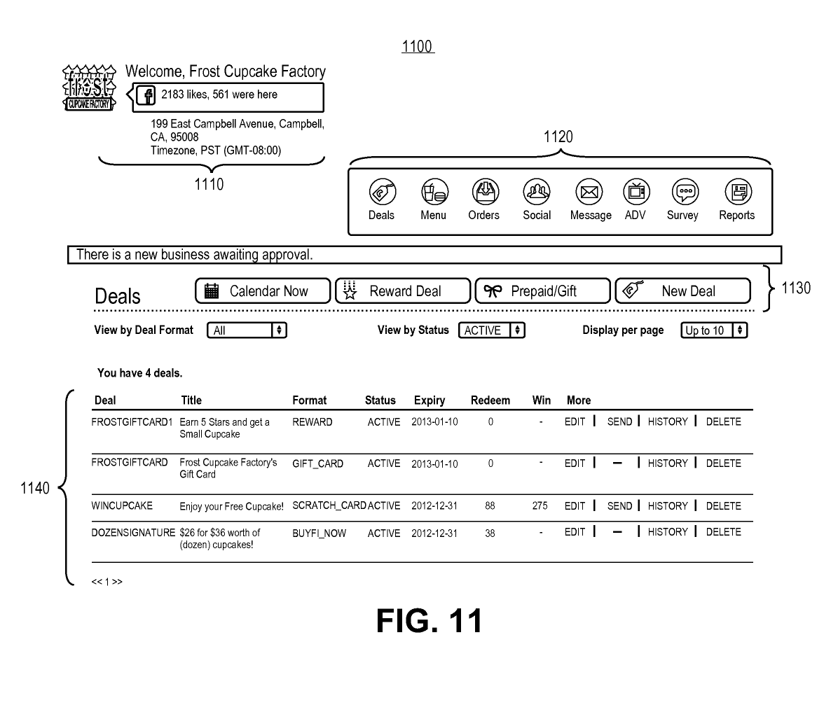

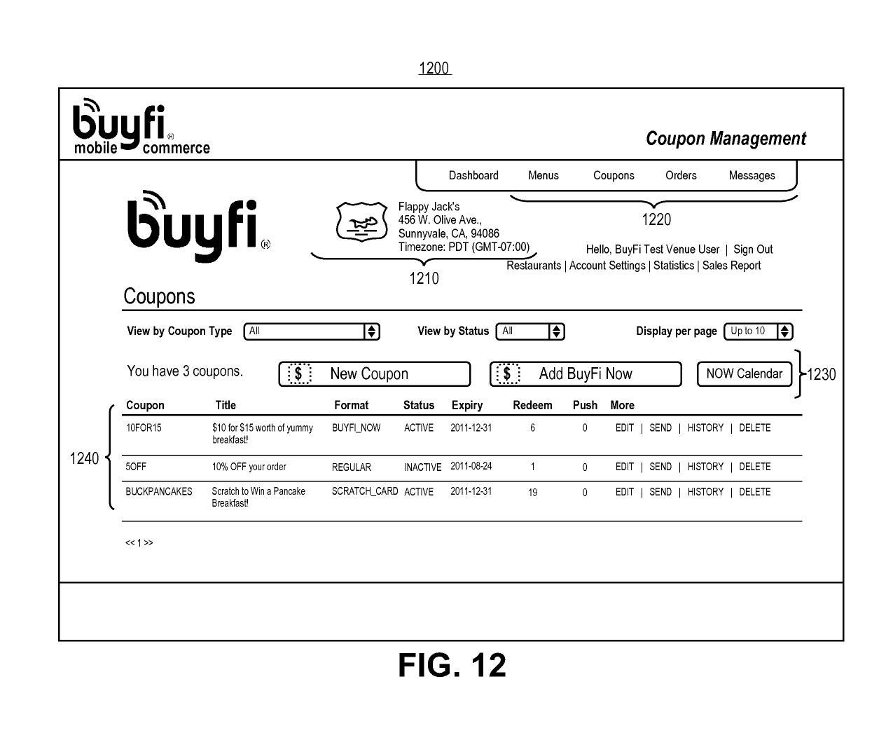

FIG. 11 is an exemplary interface for a deals dashboard page. In some embodiments, deals dashboard page 1100 may include greeting area 1110, toolbar 1120, deals pane 1130, and deals list 1140. Greeting area 1110 may display a general greeting and basic information about the restaurant such as a name, address, and time zone. Greeting area 1110 may also include information gathered from social media accounts associated with the restaurant. Such information may include the number of Facebook® users that have visited the “Facebook® Page” associated with the restaurant or the number of “Facebook® Likes” that users have associated with the restaurant. Toolbar 1120 may include selectable icons that link to other interfaces within the system. When selected, each icon provides an interface associated with that particular icon. Deals pane 1130 may include selectable icons that link to interfaces associated with particular categories of deals. When selected, each icon provides an interface associated with that particular icon. For example, the new deal icon may provide the merchant with one of the exemplary deal control pages discussed below. Deals list 1140 may include a list of current deals. Deals list 1140 may also display various information associated with each deal, such as the format of the deal, the current status of the deal, the expiration date of the deal, or data relating to how many deals have been redeemed. Deals list 1140 may also include selectable links that provide interfaces for editing, sending, or deleting a deal, or for viewing a history associated with a particular deal. FIG. 12 is an additional exemplary interface for a deals dashboard page. Deals dashboard page 1200 may include identification pane 1210, toolbar 1220, deals pane 1230, and deals list 1240, each of which may be similar in functionality to the inputs shown in FIG. 11.

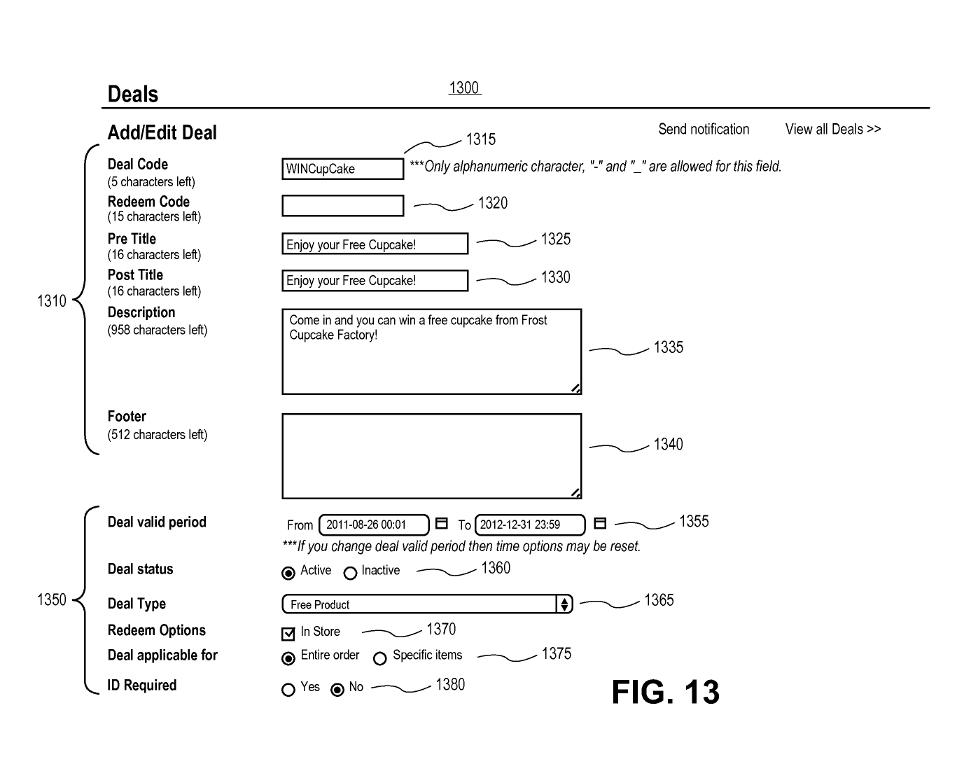

FIG. 13 is an exemplary interface for a deal control page. In some embodiments, deal control page 1300 may include deal description area 1310 and deal settings area 1350. Descriptive information about a deal may be received at the fields included in deal description area 1310. In various embodiments, a deal may be a prepaid deal, a reward deal, a gift card deal, a discount, a coupon, or any other form of deal. Such fields may include a deal code field 15, a redeem code field 1320, title fields 1325 and 1330, a description field 1335, and a footer field 1340. Parameters for a deal may be received via the selectable inputs included in deal settings area 1350. Such selectable inputs may include a time interval 1355, a deal status selector 1360, a deal type dropdown menu 1365, a redeem options selector 1370, a deal applicability selector 1375, and an ID requirement selector 1380. The selectable inputs allow a merchant to control parameters for a deal. For example, the deal status selector 1360 may allow a merchant to render a deal active or inactive. The deal type drop-down menu 1365 may allow a merchant to choose from a variety of deals, such as a free product, a discounted product, or any other type of deal. Deal applicability selector 1375 may allow a merchant to control whether a deal applies to an entire restaurant or specific items within the restaurant. ID requirement selector 1380 may allow a merchant to control whether a user must present identification when redeeming the deal.

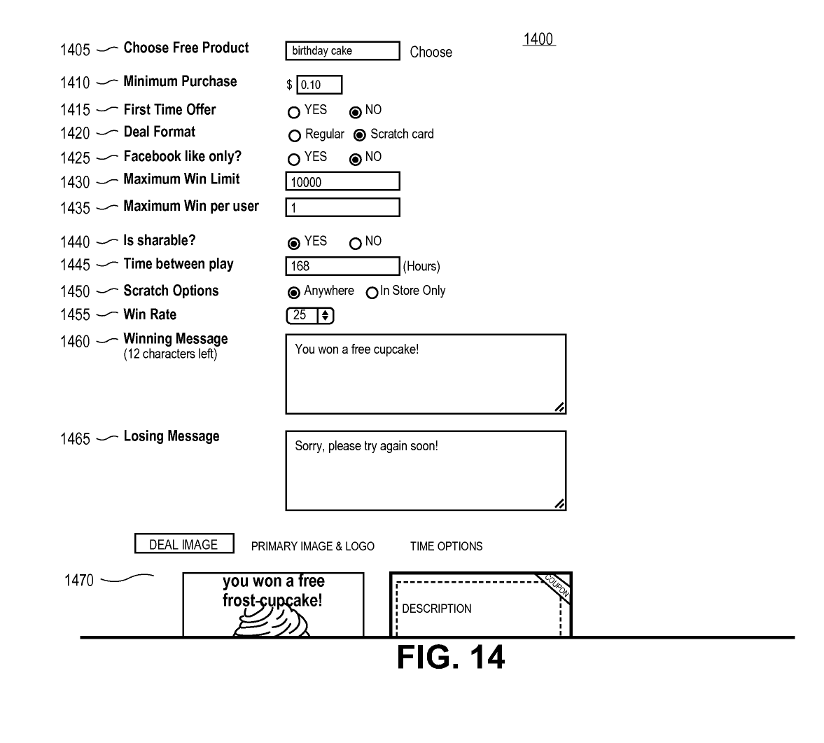

FIG. 14 shows additional illustrative inputs in an exemplary interface for a deal control page. In some embodiments, deals control page 1400 may include additional selectable inputs such as a free product field 1405, a minimum purchase field 1410, a first time offer selector 1415, a deal format selector 1420, a Facebook® Like selector 1425, a maximum win limit field 1430, a maximum win per user field 1435, a share selector 1440, a time interval field 1445, a scratch options selector 1450, a win rate dropdown menu 1455, a winning message field 1460, a losing message field 1465, and a deal image selector 1470. In some embodiments, these selectable additional inputs allow a merchant to further control parameters for a deal. For example, deal format selector 1420 may allow a merchant to control whether a deal is presented in regular format or in a “scratch card” format. A “scratch card” deal may allow a user to either win a deal or receiving a losing message. Win rate dropdown menu 1455 may allow a merchant to control the rate at which a user should win a deal, while time interval field 1445 may allow the merchant to control how often a user can attempt to win a deal. Message fields 1460 and 1465 may allow a merchant to display various messages depending on whether or not the user won a deal.

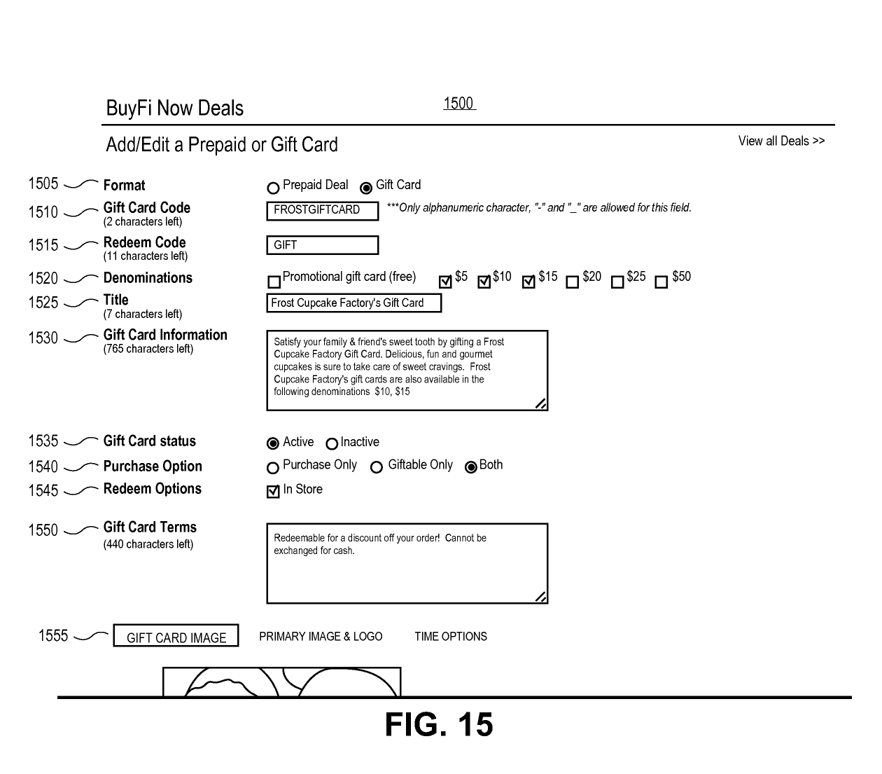

FIG. 15 is an additional exemplary interface for a deal control page. In some embodiments, parameters for a gift card deal may be received via the fields and selectable inputs included in gift card settings page 1500. Such fields and selectable inputs may include a format selector 1505, a gift card code 1510, a redeem code 1515, a denominations selector 1520, a title field 1525, a gift card information field 1530, a gift card status selector 1535, a purchase option selector 1540, a redeem options selector 1545, a gift card terms field 1550 and a gift card image selector 1555.

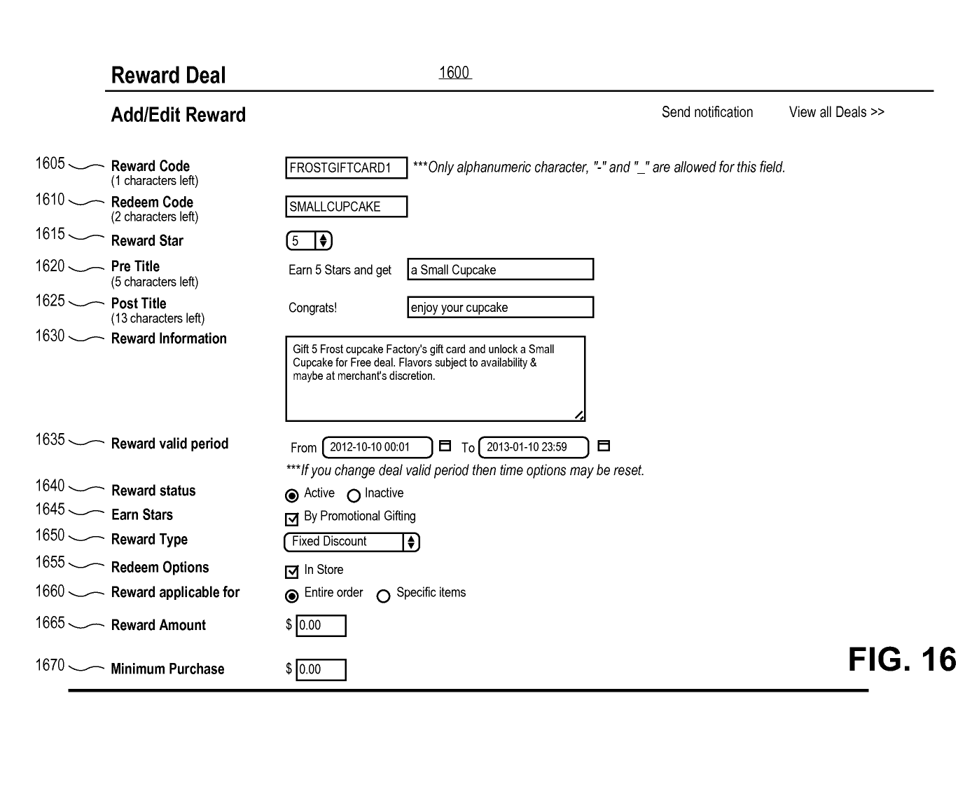

FIG. 16 is an additional exemplary interface for a deal control page. In some embodiments, parameters for a reward deal may be received via the fields and selectable inputs included in reward deal settings page 1600. In some embodiments, the parameters may include information about the purchasing history of a user. For example, such fields and selectable inputs may include a reward code field 1605, a redeem code field 1610, a reward quantity dropdown menu 1615, title fields 1620 and 1625, a reward information field 1630, a time interval 1635, a reward status selector 1640, a loyalty level selector 1645, a reward type dropdown menu 1650, a redeem options selector 1655, a reward applicability selector 1660, a reward amount field 1665, and a minimum purchase amount 1670. The loyalty level selector 1645 may allow a merchant to control the loyalty level that a user must have in order to receive the deal. In some embodiments, the loyalty level of a user may be based on the purchasing history of the user.

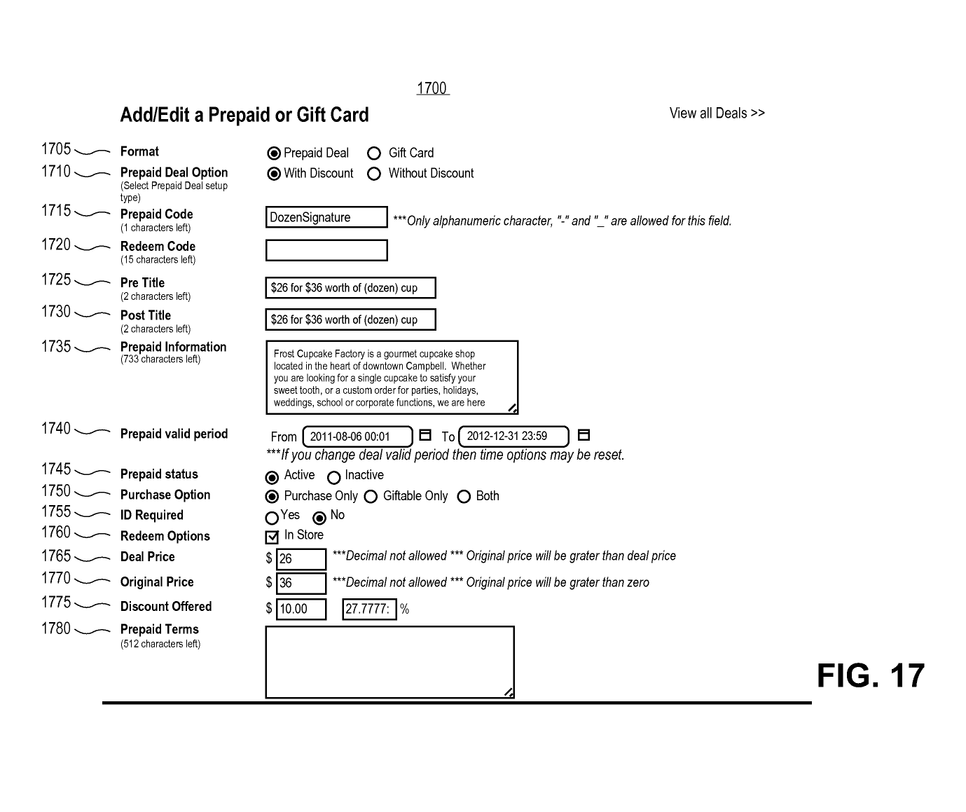

FIG. 17 is an additional exemplary interface for a deal control page. In some embodiments, parameters for a prepaid deal may be received via the fields and selectable inputs included in prepaid deal settings page 1700. Such fields and selectable inputs may include a format selector 1705, a discount option selector 1710, a prepaid code field 1715, a redeem code field 1720, title fields 1725 and 1730, a prepaid deal information field 1735, a time interval 1740, a status selector 1745, a purchase option selector 1750, an ID requirement selector 1755, a redeem options selector 1760, a deal price field 1765, an original price field 1770, a discount offered field 1775, and a prepaid terms field 1780.

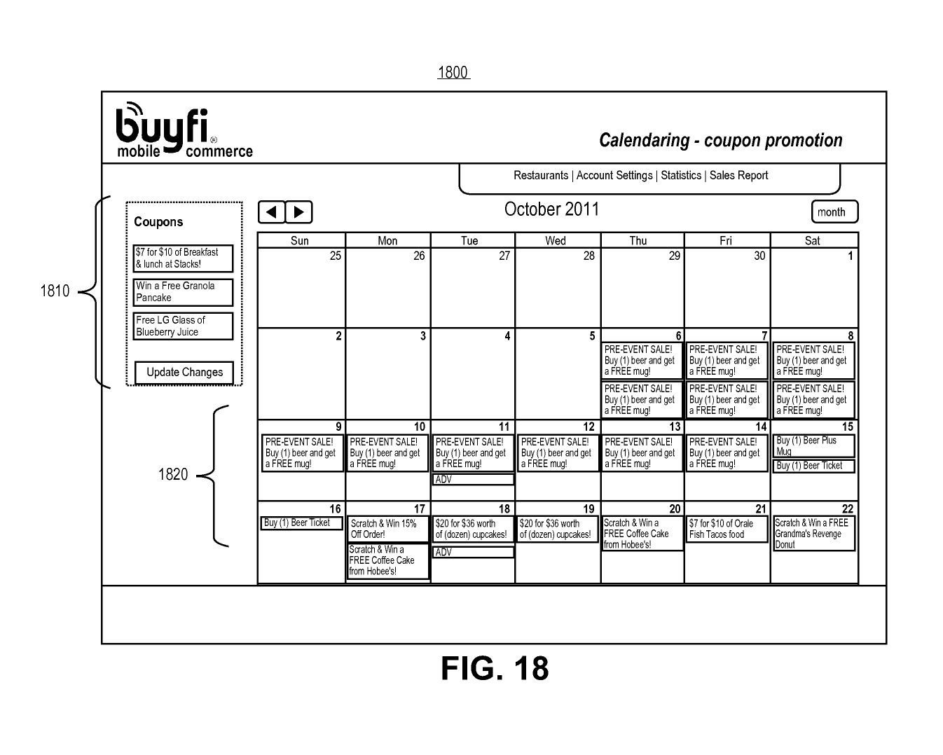

FIG. 18 is an exemplary interface for a deal scheduling page. In some embodiments, deal scheduling page 1800 may include deal panel 1810 and deal calendar 1820. Deals may be scheduled to automatically become active on a particular date via fields in deal panel 1810. Deal calendar 1820 may displays scheduled deals. In some embodiments, the deals scheduled on deal calendar 1820 may be automatically provided to a user.

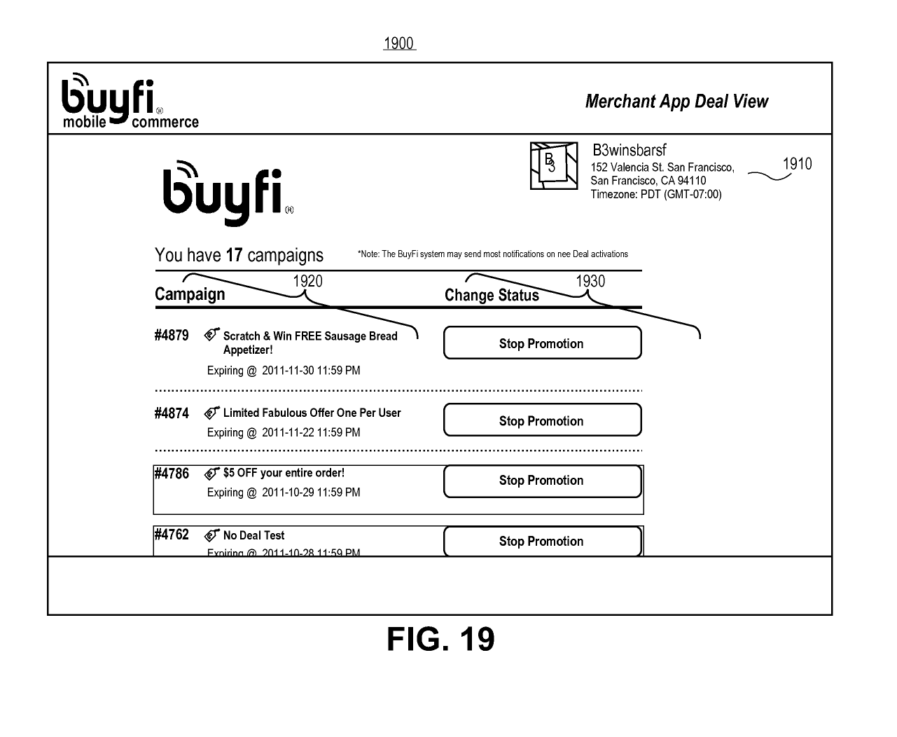

FIG. 19 is an exemplary interface for a point-of-sale deal control page. In some embodiments, point-of-sale deal control page 1900 may include identification pane 1910, deal list 1920, and deal status panel 1930. Point-of-sale deal control page 1900 may be displayed on a point-of-sale terminal in the restaurant. Identification pane 1910 may display basic information about the restaurant such as a name, address, and time zone. Deal list 1920 may display active or pending deals, including information associated with each deal such as a number, description, or expiration date. Deal status panel 1930 may include selectable inputs for starting a deal, stopping a deal, and displaying the current status of a deal.

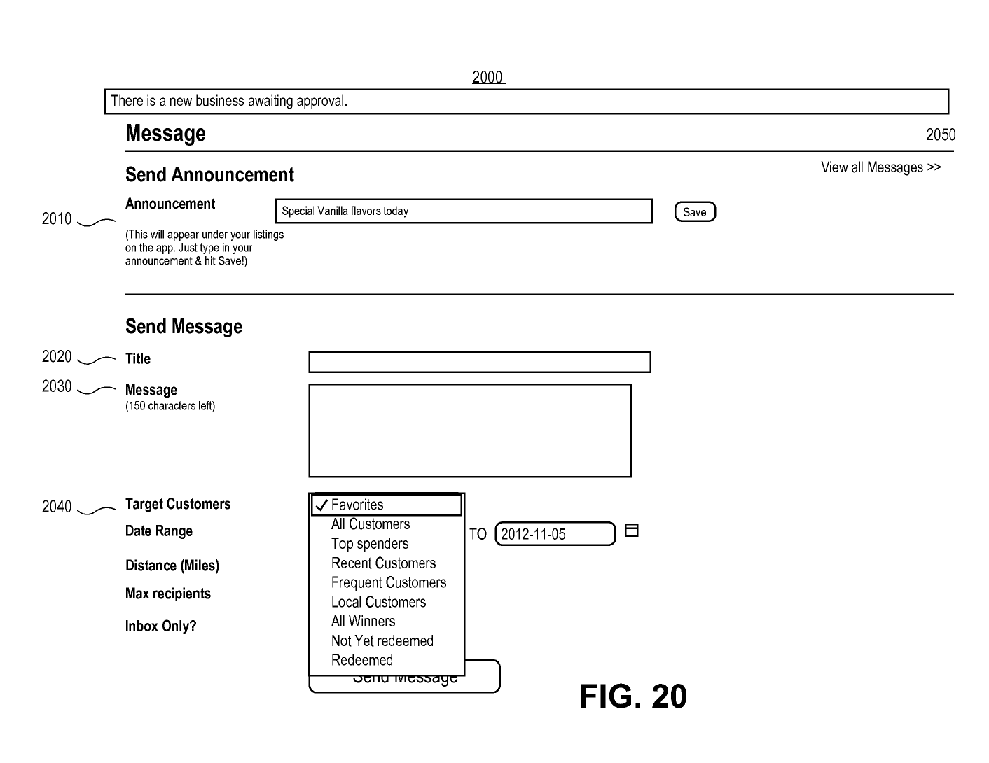

FIG. 20 is an exemplary interface for a message control page. In some embodiments, message control page 2000 may include an announcement field 2010. Parameters for controlling a message may also be received at various fields, such as message title field 2020, message body field 2030, and target customer dropdown menu 2040. In some embodiments, target customer dropdown menu 2040 may include target customer parameters such as all customers, top spenders, recent customers, frequent customers, local customers, all winners, not yet redeemed, or redeemed. Such parameters may be based on the purchasing history of a user or the distance between the user and the restaurant. Message control page 2000 may also include a selectable link 2050 that, when selected, provides an interfaces that includes a list of all previously entered messages and a list of successful recipients of the message.

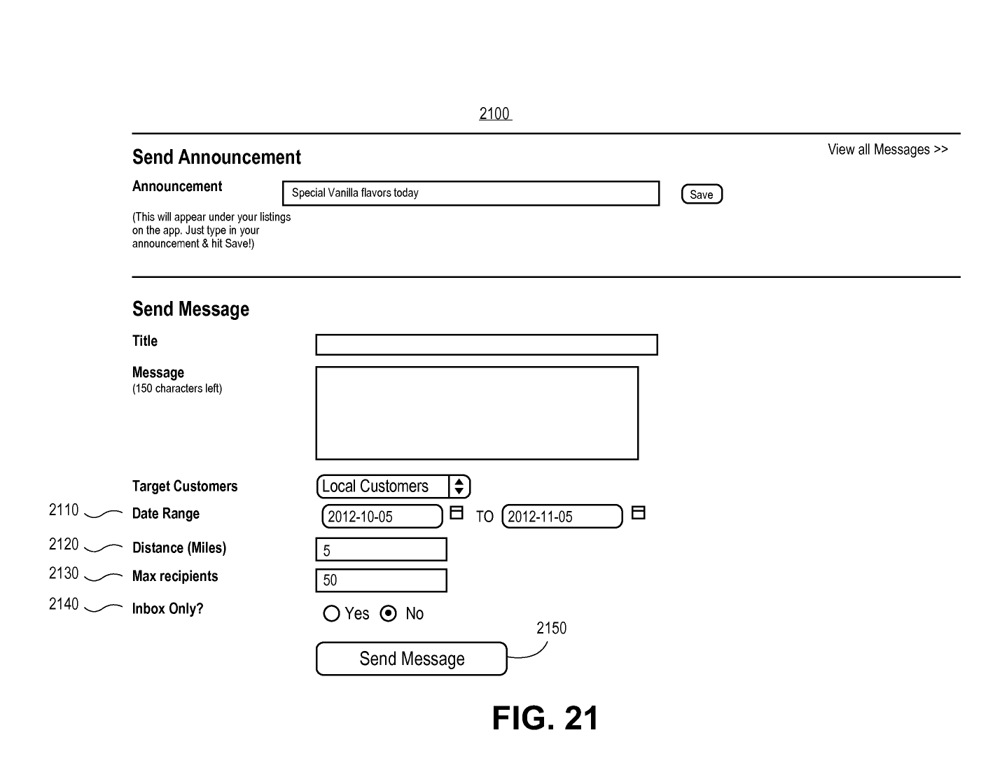

FIG. 21 shows additional illustrative inputs in an exemplary interface for a message control page. In some embodiments, a message control page 2100 may include additional selectable inputs such date range field 2110, a distance field 2120, a max recipients field 2130, and a delivery selector 2140. Distance field 2120 may allow a merchant to control the radius in which a message is provided. Only users within the specified radius will receive the message. Max recipients field 2130 may allow a merchant to control how many users receive the message. These parameters may allow a merchant to focus on users that are both local and loyal rather than mass-messaging customers that are unlikely to result in repeat business. A command to distribute a message according to the settings received by the message control page 2100 may be received when the merchant selects message trigger 2150.

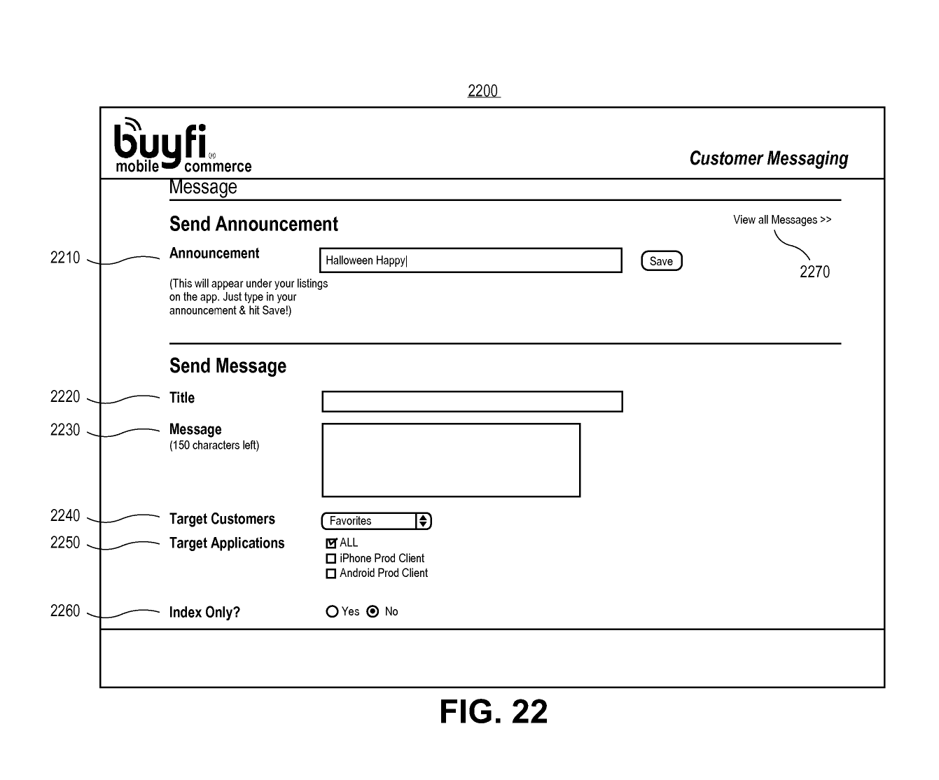

FIG. 22 is an additional exemplary for a message control page. In some embodiments, message control page 2200 may include an announcement field 2210. Parameters for controlling a message may also be received at various fields, such as message title field 2220, message body field 2230, target customer dropdown menu 2240, a target applications selector 2250, and a delivery selector 2260. Message control page 2200 may also include a selectable link 2270 that, when selected, provides an interfaces that includes a list of all previously inputted message information.

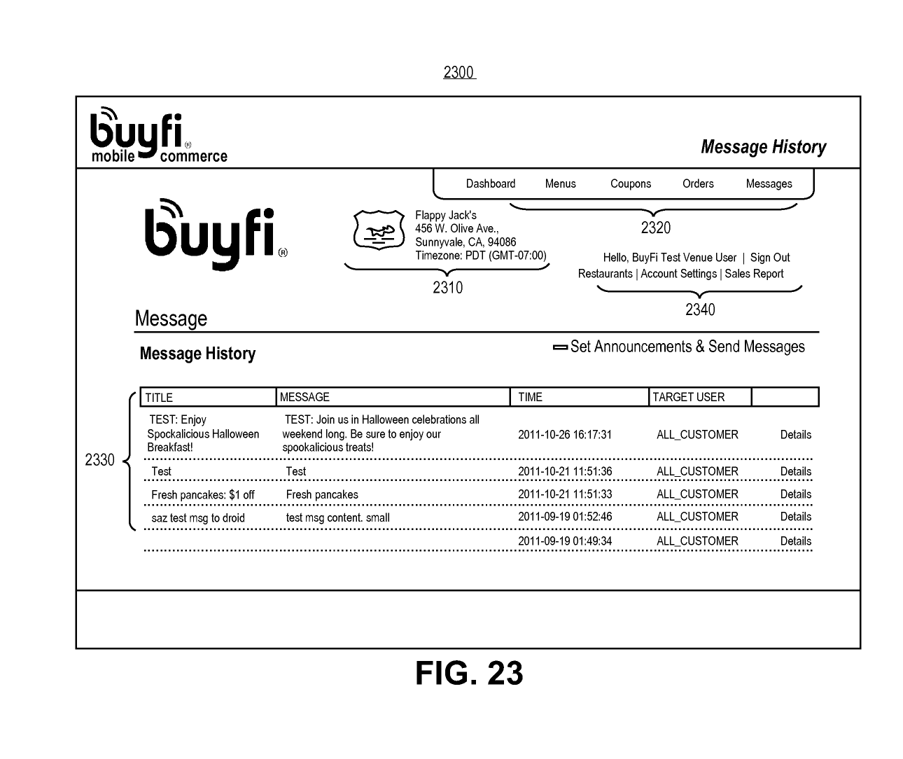

FIG. 23 is an exemplary interface for a message history page. In some embodiments, a message history page 2300 may include an identification pane 2310, a restaurant toolbar 2320, a message history window 2330, and a venue toolbar 3240. Identification pane 2310 may display basic information about the restaurant such as a name, address, and time zone. Toolbar 2320 may include selectable icons that link to other interfaces within the system. When selected, each icon provides an interface associated with that particular icon. Message history window 2330 may include a list of previously inputted message information, including the title, body, time, and target user of a message. Message history 2330 may also include a selectable link that, when selected, provides an interface that includes additional details about each message.

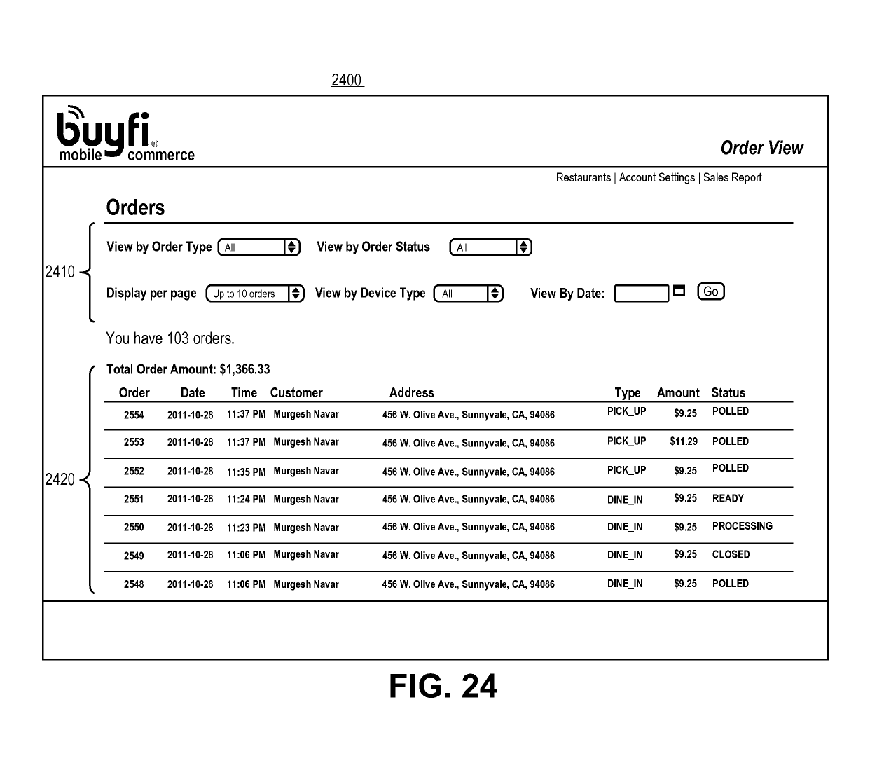

FIG. 24 is an exemplary interface for an activity information page. In some embodiments, activity information page 2400 may include information about restaurant orders. Order information may be sorted via dropdown filters or fields in order sorting pane 2410. Order window 2420 may include a list of previously received order information, including the number, date, time, customer, address, type, amount, and status of each order.

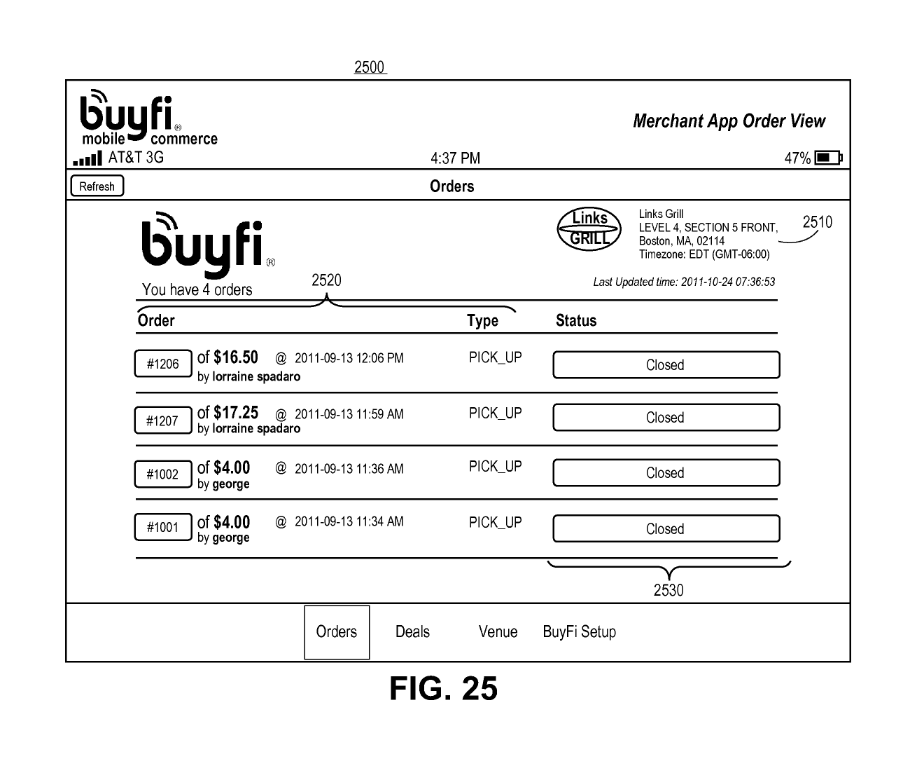

FIG. 25 is an exemplary interface for a point-of-sale activity information page. In some embodiments, point-of-sale activity information may include information about restaurant orders. Point-of-sale activity information page 2500 may include identification pane 2510, order list 2520, and order status panel 2530. Point-of-sale activity information page 2500 may be displayed on a point-of-sale terminal in the restaurant. Identification pane 2510 may display basic information about the restaurant such as a name, address, and time zone. Order list 2520 may display pending or completed orders, including information associated with each order such as a number, description, or expiration date. Order status panel 2530 may include selectable inputs for opening an order, closing an order, and displaying the current status of an order.

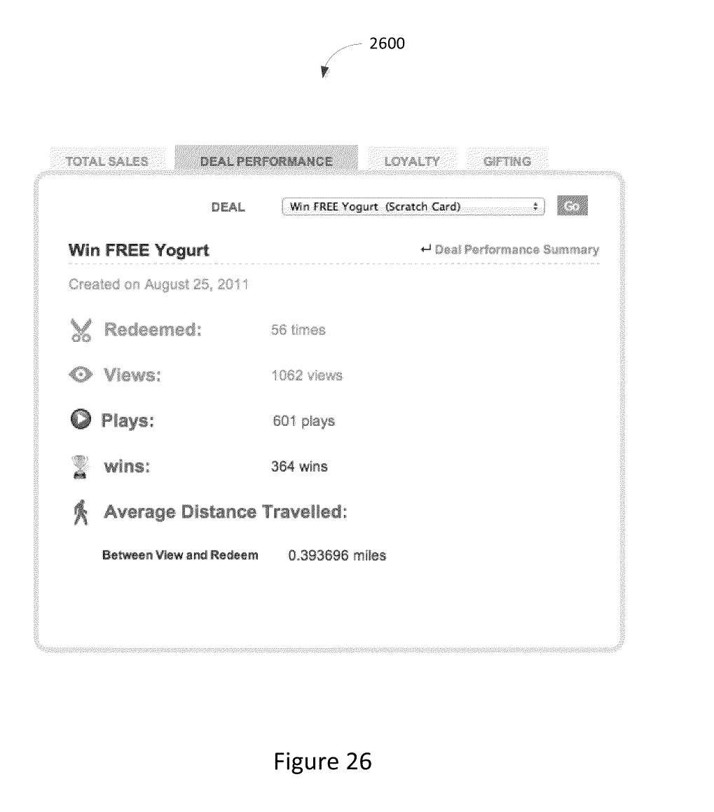

FIG. 26 is an exemplary interface 2600 providing promotion performance data. The present system may provide a merchant with promotion performance data for promotions offered in any form. For example, with regard to a deal/promotion such as a digital scratch card, the promotion performance data that can be provided may include the number or promotion offers redeemed, the number of times the promotion was viewed, the number of times a digital scratch card was played, the number of times a user won at a the digital scratch card for the promotion, and the average distance traveled from a promotion view to store location by a user.

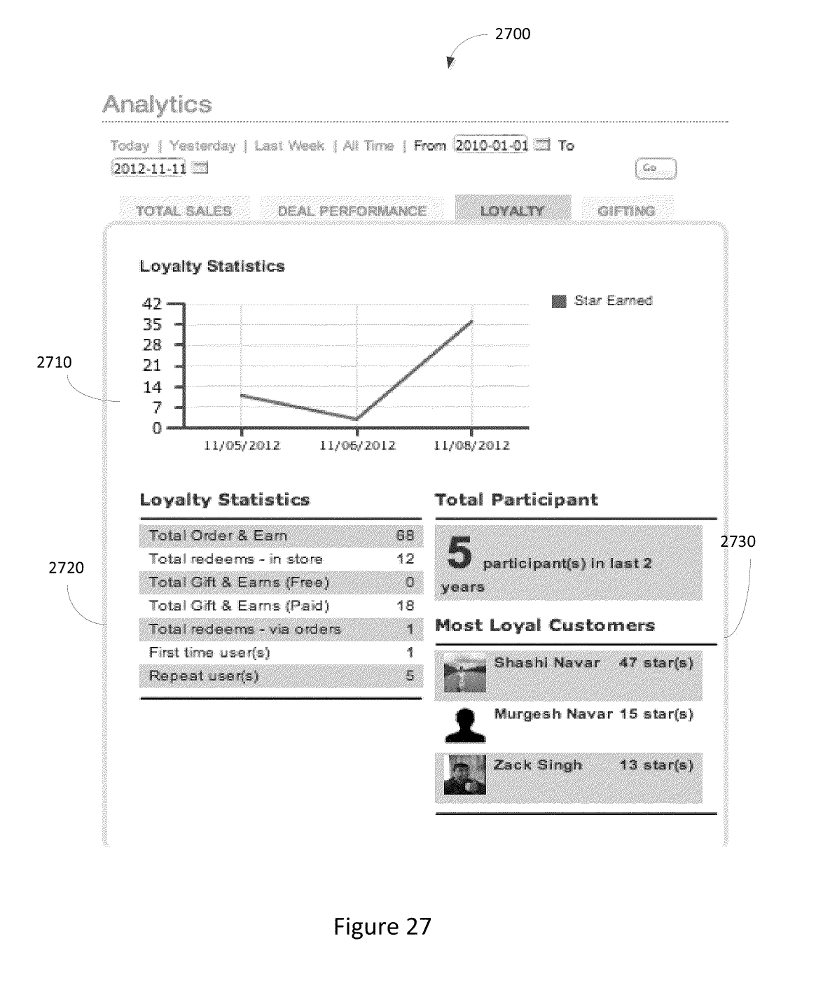

FIG. 27 is an exemplary interface 2700 providing loyalty performance data. The loyalty performance data of FIG. 2700 may include graphical data 2710, data table 2720, and data lists 2730. Graphical data 2710 may include the number of users that earned a star or performed some other activity over a period of time. Data table 2720 may include statistics such as total order and earn, total redeems in a store, total gift and earn (both free and paid), total redeem via orders, first time users and repeat orders. The data list may include statistics such as the number of participants over a period of time (such as the last month, a number of months, year or number of years) as well as the most loyal customers and information for each customer (image, name, stars, etc).

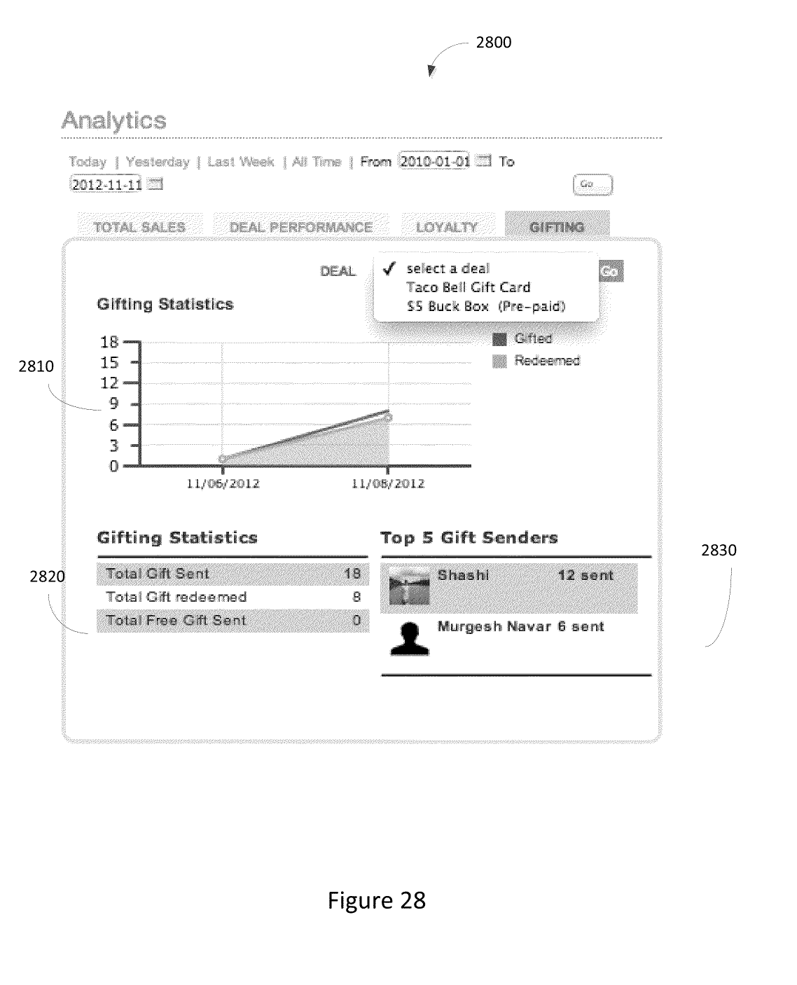

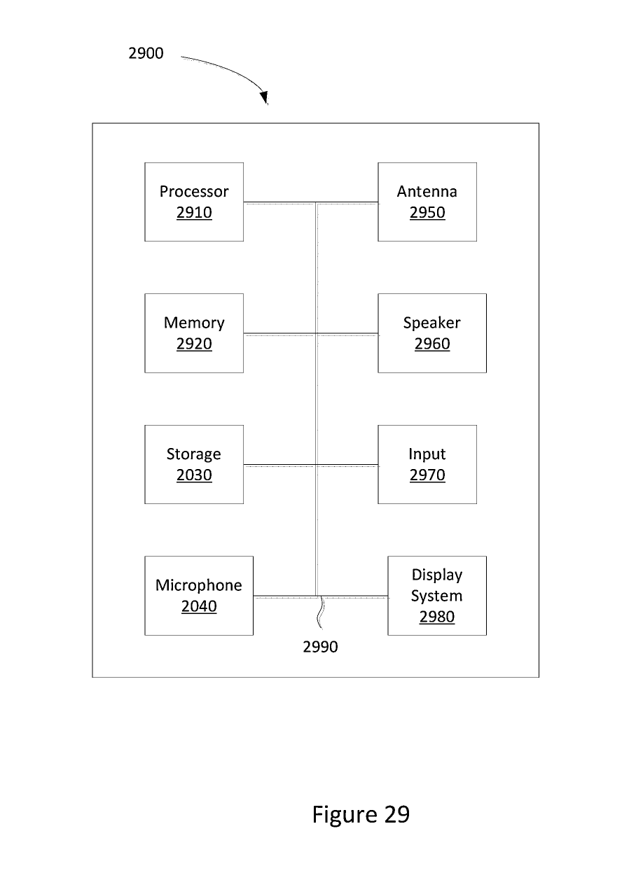

FIG. 28 is an exemplary interface 2800 providing gifting performance data. The interface 2800 may include a graphical portion 2810, gifting statistics table 2820, and gift sender information 2830 for one or more deals selected by a merchant. Graphical portion 2810 may provide statistics such as the number of deals gifted and redeemed over a period of time. Gifting statistics table 2820 may provide statistics such as the total gifts sent, total gifts redeemed, and total free gifts sent. Gift sender information 2830 may include the top five gift senders, which information for each gift sender such as name, an image and number of gifts sent.

FIG. 29 illustrates an exemplary computing system 2900 that may be used to implement a computing device for use with the present technology. System 2900 of FIG. 29 may be implemented in the contexts of the likes of client computer 110, terminal 130, application server 150 and data store 160. The computing system 2900 of FIG. 29 includes one or more processors 2910 and memory 2910. Main memory 2910 stores, in part, instructions and data for execution by processor 2910. Main memory 2910 can store the executable code when in operation. The system 2900 of FIG. 29 further includes a mass storage device 2930, portable storage medium drive(s) 2940, output devices 2950, user input devices 2960, a graphics display 2970, and peripheral devices 2980.

The components shown in FIG. 29 are depicted as being connected via a single bus 2990. However, the components may be connected through one or more data transport means. For example, processor unit 2910 and main memory 2910 may be connected via a local microprocessor bus, and the mass storage device 2930, peripheral device(s) 2980, portable storage device 2940, and display system 2970 may be connected via one or more input/output (I/O) buses.

Mass storage device 2930, which may be implemented with a magnetic disk drive or an optical disk drive, is a non-volatile storage device for storing data and instructions for use by processor unit 2910. Mass storage device 2930 can store the system software for implementing embodiments of the present invention for purposes of loading that software into main memory 2910.

Portable storage device 2940 operates in conjunction with a portable non-volatile storage medium, such as a floppy disk, compact disk or Digital video disc, to input and output data and code to and from the computer system 2900 of FIG. 29. The system software for implementing embodiments of the present invention may be stored on such a portable medium and input to the computer system 2900 via the portable storage device 2940.

Input devices 2960 provide a portion of a user interface. Input devices 2960 may include an alpha-numeric keypad, such as a keyboard, for inputting alpha-numeric and other information, or a pointing device, such as a mouse, a trackball, stylus, or cursor direction keys. Additionally, the system 2900 as shown in FIG. 29 includes output devices 2950. Examples of suitable output devices include speakers, printers, network interfaces, and monitors.

Display system 2970 may include a liquid crystal display (LCD) or other suitable display device. Display system 2970 receives textual and graphical information, and processes the information for output to the display device.

Peripherals 2980 may include any type of computer support device to add additional functionality to the computer system. For example, peripheral device(s) 2980 may include a modem or a router.

The components contained in the computer system 2900 of FIG. 29 are those typically found in computer systems that may be suitable for use with embodiments of the present invention and are intended to represent a broad category of such computer components that are well known in the art. Thus, the computer system 2900 of FIG. 29 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

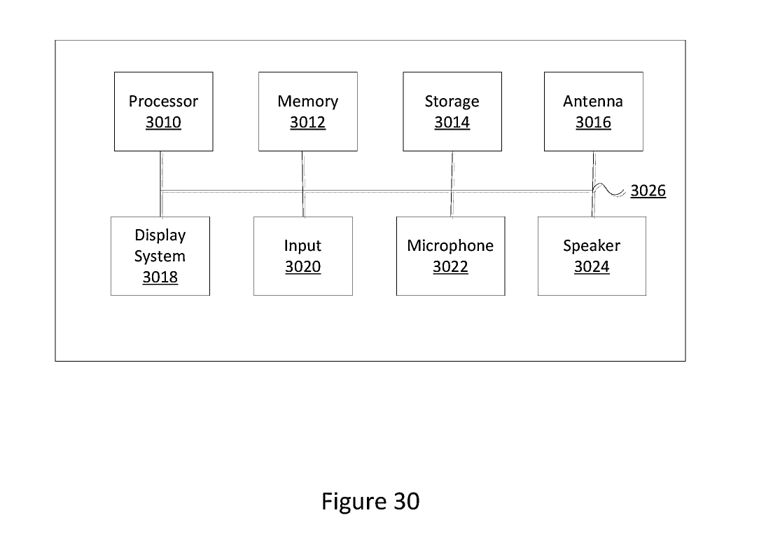

FIG. 30 illustrates an exemplary mobile device system 3000 that may be used to implement a mobile device for use with the present technology, such as for mobile device 120. The mobile device 3000 of FIG. 30 includes one or more processors 3010 and memory 3012. Memory 3012 stores, in part, programs, instructions and data for execution and processing by processor 3010. The system 3000 of FIG. 30 further includes storage 3014, one or more antennas 3016, a display system 3018, inputs 3020, one or more microphones 3022, and one or more speakers 3024.

The components shown in FIG. 30 are depicted as being connected via a single bus 3026. However, the components 3010-1024 may be connected through one or more data transport means. For example, processor unit 3010 and main memory 3012 may be connected via a local microprocessor bus, and storage 3014, display system 3018, input 3020, and microphone 3022 and speaker 3024 may be connected via one or more input/output (I/O) buses.

Memory 3012 may include local memory such as RAM and ROM, portable memory in the form of an insertable memory card or other attachment (e.g., via univerisal serial bus), a magnetic disk drive or an optical disk drive, a form of FLASH or PROM memory, or other electronic storage medium. Memory 3012 can store the system software for implementing embodiments of the present invention for purposes of loading that software into main memory 3010.

Antenna 3016 may include one or more antennas for communicating wirelessly with another device. Antenna 3016 may be used, for example, to communicate wirelessly via Wi-Fi, Bluetooth, with a cellular network, or with other wireless protocols and systems. The one or more antennas may be controlled by a processor 3010, which may include a controller, to transmit and receive wireless signals. For example, processor 3010 execute programs stored in memory 3012 to control antenna 3016 transmit a wireless signal to a cellular network and receive a wireless signal from a cellular network.

Display system 3018 may include a liquid crystal display (LCD), a touch screen display, or other suitable display device. Display system 3070 may be controlled to display textual and graphical information and output to text and graphics through a display device. When implemented with a touch screen display, the display system may receive input and transmit the input to processor 3010 and memory 3012.

Input devices 3020 provide a portion of a user interface. Input devices 3060 may include an alpha-numeric keypad, such as a keyboard, for inputting alpha-numeric and other information, buttons or switches, a trackball, stylus, or cursor direction keys.

Microphone 3022 may include one or more microphone devices which transmit captured acoustic signals to processor 3010 and memory 3012. The acoustic signals may be processed to transmit over a network via antenna 3016.

Speaker 3024 may provide an audio output for mobile device 3000. For example, a signal received at antenna 3016 may be processed by a program stored in memory 3012 and executed by processor 3010. The output of the executed program may be provided to speaker 3024 which provides audio. Additionally, processor 3010 may generate an audio signal, for example an audible alert, and output the audible alert through speaker 3024.

The mobile device system 3000 as shown in FIG. 30 may include devices and components in addition to those illustrated in FIG. 30. For example, mobile device system 3000 may include an additional network interface such as a universal serial bus (USB) port.

The components contained in the computer system 3000 of FIG. 30 are those typically found in mobile device systems that may be suitable for use with embodiments of the present invention and are intended to represent a broad category of such mobile device components that are well known in the art. Thus, the computer system 3000 of FIG. 30 can be a cellular phone, smart phone, hand held computing device, minicomputer, or any other computing device. The mobile device can also include different bus configurations, networked platforms, multi-processor platforms, etc. Various operating systems can be used including Unix, Linux, Windows, Macintosh OS, Google OS, Palm OS, and other suitable operating systems.

Embodiments of the invention provide a system with a complete platform connecting merchants to mobile consumers. The system provides restaurants with a comprehensive platform to accept orders, process payments, manage customers, and offer deals or loyalty programs to their social and mobile customers. The system includes fast-casual and quick service restaurants on college campuses, in neighborhoods and stadiums. The present technology connects merchant point-of-sale (“POS”) systems to consumer smart phones with an incredibly easy and quick-to-deploy solution. With this turnkey go-live process and basic promotion to existing customers, an average counter service restaurant using the present technology can expect large amounts of revenue per year in incremental revenues through larger checks, more frequent and more accurate orders.

Unlike prior art systems, the present system provides a complete suite of ordering, payment, marketing and loyalty services for restaurants, integrated with the POS, giving merchants total control. Consumers get convenience, amazing deals, can easily send gifts to their Facebook friends, order ahead, skip lines and earn rewards. A typical transaction on the present system is completed in less than two minutes.

The present technology transforms the retail point-of-sale system allowing restaurants to communicate with their mobile and social customers before, during and after the sale to generate more business. With the present technology, restaurants can be connected to any customer with a smart phone. The platform of the invention can be integrated directly into select POS systems, controlled via a tablet computer such as an Apple iPad or a standard web browser, or used through fax/email.

The present technology allows consumers to conveniently and accurately order ahead, pay, and earn rewards with each transaction. Credit card information is encrypted and stored securely on the mobile phone. No registration, no sign-in, no hassle.

A gift reward is a simple and fun way to give, receive and redeem gifts, and earn rewards using mobile phones with the present technology. Customers are rewarded for sending their friends to a restaurant, and are automatically reminded to gift their Facebook friends on holidays, birthdays, and other special occasions. Consumers can easily buy greatly discounted restaurant deals using the present technology, but they can also get the same deals for free by playing a simple digital scratch card game.

The present technology may be involve secure mobile transactions and mobile environments for building and rewarding customer loyalty. An example of secure mobile transactions is disclosed in more detail in U.S. patent application Ser. No. 13/294,134, titled “Securing Mobile Transactions”, filed on Nov. 10, 2011, the disclosure of which is incorporated herein by reference. An example of building customer loyalty is disclosed in more detail in U.S. patent application Ser. No. 13/550,563, titled “Building Customer Loyalty in a Mobile Environment”, filed on Jul. 16, 2012, the disclosure of which is incorporated herein by reference. An example of rewarding customer loyalty is disclosed in more detail in U.S. patent application Ser. No. 13/294,141, titled “System and Method for Rewarding Customer Loyalty in a Mobile Environment”, filed on Nov. 10, 2011, the disclosure of which is incorporated herein by reference.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A system for managing promotions and activity information in a restaurant, comprising:
a processor;
memory; and
an application stored in memory and executable by the processor to:
receive promotion information regarding a promotion offered by a restaurant merchant, the promotion information including a plurality of parameters,
access user information for one or more restaurant users,
match a user to a promotion based on the user information and the promotion information,
receive activity information regarding a restaurant activity performed by the merchant, and
provide the activity information.

2. The system of claim 1, wherein the application stored in memory is further executable by the processor to provide the promotion.

3. The system of claim 1, wherein the promotion includes information about deals.

4. The system of claim 1, wherein the promotion includes information about gifts.

5. The system of claim 1, wherein the promotion includes information about events.

6. The system of claim 1, wherein the activity information includes information about orders.

7. The system of claim 1, wherein the parameters include the distance between the user and the restaurant.

8. The system of claim 1, wherein the parameters include a win rate.

9. The system of claim 1, wherein the user information includes information about the purchasing history of the user.

10. The system of claim 1, wherein the application stored in memory is further executable by the processor to receive the promotion information from a point-of-sale terminal.

11. The system of claim 1, wherein the application stored in memory is further executable by the processor to receive the activity information from a point-of-sale terminal.

12. The system of claim 1, wherein the application stored in memory is further executable by the processor to receive the activity information from a mobile device.

13. The system of claim 2, wherein the application stored in memory is further executable by the processor to provide the promotion to a mobile device associated with a user.

14. The system of claim 2, wherein the application stored in memory is further executable by the processor to provide the promotion via an electronic mail message.

15. A method for managing promotions and activity information in a restaurant, comprising:
receiving promotion information by a server regarding a promotion offered by a restaurant merchant, the promotion information including a plurality of parameters;
accessing user information for one or more restaurant users by the server;
matching a user to a promotion by the server based on the user information and the promotion information;
receiving activity information by the server regarding a restaurant activity performed by the merchant; and
providing the activity information by the server.

16. The method of claim 15, further including providing the promotion by the server.

17. The method of claim 15, wherein the promotion includes information about deals.

18. The method of claim 15, wherein the promotion includes information about gifts.

19. The method of claim 15, wherein the promotion includes information about events.

21. The method of claim 15, wherein the activity information includes information about orders.

22. The method of claim 15, wherein the parameters include the distance between the user and the restaurant.

23. The method of claim 15, wherein the parameters include a win rate.

24. The method of claim 15, wherein the user information includes information about the purchasing history of the user.

25. The method of claim 15, wherein receiving promotion information includes receiving the promotion information from a point-of-sale terminal.

26. The method of claim 15, wherein receiving activity information includes receiving the activity information from a point-of-sale terminal.

27. The method of claim 15, wherein receiving activity information includes receiving the activity information from a mobile device.

28. The method of claim 16, wherein providing the promotion includes providing the promotion to a mobile device associated with the user.

29. The method of claim 16, wherein providing the promotion includes providing the promotion via an electronic mail message.
